(19) United States
(12) Patent Application Publication
(10) Pub. No.: US 2004/0246246 A1
(43) Pub. Date: Dec. 9, 2004

(54) Image display device with increased margin for writing image signal

(75) Inventor: Youichi Tobita, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/824,515

(22) Filed: Apr. 15, 2004

(30) Foreign Application Priority Data
Jun. 9, 2003 (JP) 2003-163788

(51) Int. Cl. H04N 5/335

(52) U.S. Cl. 345/205

(57) ABSTRACT

Pixels are arranged in rows and columns and gate lines are arranged corresponding to the rows of pixels in a display panel. Deactivation transition detect circuit detects transition of a selected gate line from a selected state to a non-selected state in the gate lines. An operation related to data writing in the next cycle is started in accordance with a deactivation transition detect signal detecting the transition. In an active matrix type display device, a write margin for data writing of the next cycle is increased when a selected gate line transits to a non-selected state.

### BACKGROUND OF THE INVENTION

1. Field of the Invention

The present invention relates to an image display device, and specifically, to an image display device capable of increasing an operating margin for writing image signal.

2. Description of the Background Art

A flat panel is coming into wide use for displaying an image with small space and less power consumption. In such flat panel, pixels are arranged in a matrix of rows and columns on a display panel for displaying an image. Each pixel includes an image display element such as a liquid crystal element and a select transistor for transmitting an image signal to the display element.

A gate line (a scanning line) is arranged corresponding to each pixel row, and a data line transmitting an image signal is arranged corresponding to each pixel column. To each gate line, the gates of the transistors of pixels in the corresponding row are connected, and to each data line, the conduction terminals of transistors of pixels in the corresponding column are connected.

The gate line corresponds to a scanning line, and a selecting period of the gate line is determined by a horizontal scanning period of an image. For example, in NTSC system where the number of horizontal scanning lines are 525, one horizontal scanning period of time is 64 μS. As this period is short, normally an active matrix scheme is employed in which one gate line is set to a selected state for the horizontal scanning period for setting the select transistors to a conductive state to write an image signal to the pixels, and the select transistors are maintained in a non-conductive state during the remaining vertical scanning period. Each pixel maintains the image signal for one field period to drive the display element for displaying the corresponding image signal.

In such an image display device, various attempts are made for displaying an image stably and precisely.

According to Japanese Patent Laying-Open No. 4-247491 (first prior art document), in order to prevent simultaneous multiple selection of pixel lines (scanning lines) in an active matrix type liquid crystal display device, a blanking signal is superimposed on a gate signal transmitted to a scanning line. As the width of the scanning line is made smaller and the number of required pixels is made greater, parasitic resistance and parasitic capacitance of the scanning line are increased, and thus the gate signal delays, requiring much time for reaching the end of the scanning line. When the propagation delay is increased, the gate signal would be accompanied with waveform rounding and adjacent scanning lines may be possibly simultaneously selected. For the period where such multiple selection of the scanning lines may occur, the blanking signal is activated to prohibit transmission of a selecting signal to the gate line. The time period where each gate line is driven from a selected state to a non-selected state is determined by the blanking signal, to delay the timing for driving the gate signal to the selected state. Thus, even when the waveform rounding occurs, scanning lines are prevented from being simultaneously driven to a selected state, to prevent unnecessary pixel data from being written to the pixels of the adjacent scanning line.

Japanese Patent Laying-Open No. 11-175027 (second prior art document) discloses a display device driving circuit for a gradation display type display device, intended to make the correspondence relationship between a written gradation voltage to a pixel and input display data adjustable. A voltage dividing circuit for generating the gradation voltage has the division ratio changed in accordance with a mode setting signal. By changing-the gradation displaying characteristics depending on an application and the device characteristics, this prior art aims to implement flexible displayed image characteristics.

According to Japanese Patent Laying-Open No. 58-49989 (third prior art document), a counter electrode of a liquid crystal display element is divided corresponding to each pixel row. For each divided counter electrode line, a flip-flop is arranged. Each flip-flop changes its output state in accordance with a select signal for a corresponding scanning line. By changing a pixel signal between two kinds of counter electrode voltages, AC (alternating-current) driving of the liquid crystal element is implemented using the power supply voltage. Additionally, necessity for inverting the pixel signal polarity of the liquid crystal element with respect to the power supply voltage is eliminated, attempting to reduce the power consumption and to improve the reliability of the element.

According to Japanese Patent Laying-Open No. 2000-250068 (fourth prior art document), in a liquid crystal display device in which gate lines are sequentially selected in synchronization with a clock signal, the clock signal is transmitted through a dummy gate line having substantially the same delay as the delay of the gate line, and the delayed clock signal from the dummy gate line is used to set the output/latch state of a drain driver (a pixel column driving circuit) for outputting pixel data. Pixels are arranged in rows and columns, a gate line is arranged corresponding to each pixel row, and a drain line is arranged corresponding to each pixel column. By transmitting pixel data to a corresponding drain line when the end of a selected gate line is driven to a selected state, it attempts to write pixel data to each pixel precisely.

In the configuration shown in the first prior art document, a blanking signal is generated in accordance with a horizontal synchronizing signal. For the active period of the blanking signal, a gate signal for an adjacent scanning line is set to a non-selected state. The active period of the blanking signal is fixedly set in advance, with a margin taken into consideration in accordance with a test result of a signal propagation delay of the scanning line. Accordingly, when the actual signal propagation delay becomes greater than the designed value due to process variations and others, multiple selection will occurs, since the preceding scanning line is still in the selected state when the blanking signal is deactivated and the next scanning line is driven to a selected state. In this case, such a problem occurs that when the data write timing is set in accordance with the blanking signal, the next image data will be overwritten to the pixel of the preceding scanning line, and thus image data cannot be written precisely.

According to the second prior art document, only the corresponding relationship between the gradation voltage and the input image data is considered. After latching pixel data for one scanning line at a first latch for latching input pixel data, the latched data of the first latch are latched into a second latch in accordance with a line clock signal generated at a prescribed timing. According to the second latch output image data, a corresponding gradation voltage is selected for each pixel. The selected gradation voltage is transmitted to a corresponding data line through a voltage follower to be written into a corresponding pixel. In other words, during display of the pixel data for one scanning line, the next image data are taken in. Upon selection of the next scanning line, the selected gradation voltage is output at a prescribed timing. Accordingly, even when the multiple selection of scanning lines does not occur, if the signal propagation delay of the scanning lines is large, image data for the next scanning line may be output before the scanning line is driven to a non-selected state, and hence multiple writing of image data would occur.

In the configuration shown in the fourth prior art document, the timing for outputting image data for a pixel is set in accordance with a delayed clock signal generated by a dummy gate line. Since no pixel is connected to the dummy gate line, the dummy gate line does not provide precisely the same delay as the propagation delay of the gate line to which pixels are connected. Therefore, when the difference between the propagation delay of the gate line and that of the dummy gate line is increased due to process variations and others, the multiple selection of gate lines may occur. Even if the multiple selection of gate lines does not occur, image data may possibly be transmitted to each data line while the pixel at the end of a selected gate line is in a non-selected state. Thus, there is caused a problem that precise image data writing cannot be performed.

As described above, in a conventional image display device, it is required to fixedly generate an internal operation control signal at a timing obtained through estimation of effects by variations in power supply voltage, temperature, manufacturing parameter and others, and therefore there has been a problem that designing a generation timing for a control signal of high speed and with adequate operating margin is difficult.

### SUMMARY OF THE INVENTION

An object of the present invention is to provide an image display device that can perform image data writing precisely.

Another object of the present invention is to provide an image display device that can increase a margin for an operation related to data writing.

An image display device according to the present invention includes: a plurality of pixel elements arranged in rows and columns; a plurality of gate lines arranged corresponding to the rows of pixel elements and driven to a selected state in a prescribed sequence, each of the plurality of gate lines transmitting a select signal for driving pixel elements of a corresponding row to a selected state when selected; a non-select transition detecting circuit arranged for the plurality of gate lines for detecting transition of the gate lines from a selected state to a non-selected state; and internal circuitry performing an operation related to next image data writing in response to the non-select transition detecting circuit detecting the transition to a non-selected state.

By detecting transition of a gate line in a selected state to a non-selected state to control the operation related to next image data writing operation, a control signal can be generated at the timing in accordance with the actual state of the internal circuitry, and the optimum operation timing for which operation speed and a timing margin are considered can be designed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the overall configuration of an image display device according to the present invention.

FIG. 2 is a signal waveform diagram representing the operation of the image display device shown in FIG. 1.

FIG. 3 schematically shows the configuration of main parts of the image display device according to a first embodiment of the present invention.

FIG. 4 schematically shows the configuration of a pixel shown in FIG. 3.

FIG. 5 shows the configuration of a deactivation detect circuit shown in FIG. 3.

FIG. 6 shows the configuration of a gate line drive circuit shown in FIG. 3.

FIG. 7 is a signal waveform diagram representing the operation of the image display device according to the first embodiment of the present invention.

FIG. 8 schematically shows an exemplary configuration of a precharge instruct signal generating portion shown in FIG. 5.

FIG. 9 is a timing diagram representing the operation of the precharge instruct signal generating portion shown in FIG. 8.

FIG. 10 shows another configuration of the precharge instruct signal generating portion.

FIG. 11 is a signal waveform diagram representing the operation of the precharge instruct signal generating portion shown in FIG. 10.

FIG. 12 schematically shows the configuration of a main part of a modification of the first embodiment of the present invention.

FIG. 13 shows one example of the configuration of deactivation detect circuit shown in FIG. 12.

FIG. 14 is a signal waveform diagram representing the operation of a deactivation detect circuit shown in FIG. 13.

FIG. 15 shows one example of the configuration of the activation control signal generating portion shown in FIG. 13.

FIG. 16 is a signal waveform diagram representing the operation of an activation control signal generating portion shown in FIG. 15.

FIG. 17 shows the configuration of a main part of an image processing device according to a second embodiment of the present invention.

FIG. 18 is a signal waveform diagram representing the operation of a circuit shown in FIG. 17.

FIG. 19 schematically shows the configuration of a main part of the image display device according to the third embodiment of the present invention.

FIG. 20 is a signal waveform diagram representing the operation of the image display device shown in FIG. 19.

FIG. 21 schematically shows the configuration of an image display device according to a fourth embodiment of the present invention.

FIG. 22 is a signal waveform diagram representing the operation of the image display device shown in FIG. 21.

FIG. 23 shows an exemplary configuration of an input signal generating portion shown in FIG. 21.

FIG. 24 is a timing diagram representing the operation of the input signal generating portion shown in FIG. 23.

FIG. 25 schematically shows the configuration of an image display device according to a fifth embodiment of the present invention.

FIG. 26 shows the configuration of a part related to a dummy pixel matrix shown in FIG. 25.

FIG. 27 is a signal waveform diagram representing the operation of a circuit shown in FIG. 26.

FIG. 28 shows the configuration of a pixel used in a sixth embodiment of the present invention.

### DESCRIPTION OF THE PREFERRED EMBODIMENTS

Principle Configuration of the Invention

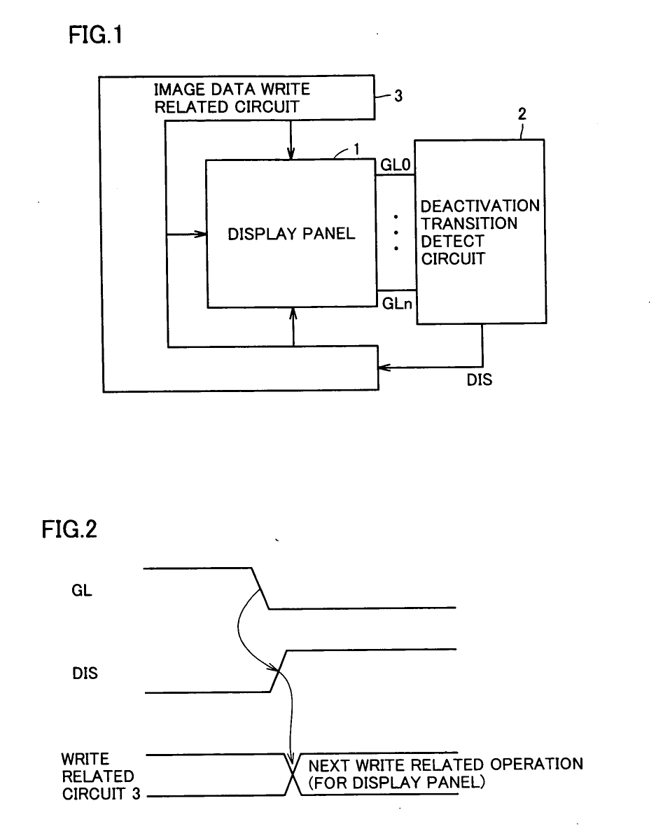

FIG. 1 schematically shows the configuration of an image display device according to the present invention. In FIG. 1, the image display device includes a display panel 1 having pixels arranged in a matrix of rows and columns, a deactivation transition detect circuit 2 for detecting transition of gate lines GL0-GLn arranged corresponding to rows of the pixels of display panel 1 from a selected state (active state) to a non-selected state (inactive state), and an image data write related circuit (internal circuit) 3 for performing an operation related to image data writing for the next row of pixels in display panel 1 according to a deactivation transition detect signal DIS from deactivation transition detect circuit 2.

In display panel 1, pixels are arranged in a matrix of rows and columns, and gate lines GL0-GLn are driven to a selected state in a prescribed sequence. In this display panel 1, data lines each transmitting a pixel data signal are arranged corresponding to the columns of the pixels.

Deactivation transition detect circuit 2 monitors the potential change for each of gate lines GL0-GLn, and drives a deactivation transition detect signal DIS to an active state when a gate line in a selected state is driven to a non-selected state.

Image data write related circuit 3 includes a gate line drive circuit for sequentially driving the gate lines in display panel 1, a data line drive circuit for generating and transmitting a pixel data signal for a pixel in display panel 1, and a counter electrode drive circuit for changing the level of voltage VCNT of a counter electrode at a gate line select cycle in the case when the pixels of display panel 1 are liquid crystal elements.

When deactivation transition detect signal DIS attains an active state, it is indicated that the gate line in a selected state is driven to a non-selected state, and then next image data writing is performed.

Specifically, as shown in a signal waveform of FIG. 2, when selected gate line GL (any of GL0-GLn) is detected to have fallen from a selected state (H level) to a non-selected state (L level), deactivation transition detect signal DIS is driven to an active state (H level). Even when the load on gate lines GL0-GLn is large and a signal propagation delay of the gate lines exist, by detecting a gate line potential at the farthest portion, deactivation transition detect signal DIS can reliably be driven to an active state when the gate line in selected state is entirely driven to a non-selected state.

In display panel 1, after a gate line in a selected state is returned to a non-selected state, the operation related to writing of next image data signal is performed. Thus, two-fold writing of pixel data signals, overwriting of pixel data signals due to a multiple selection of gate lines and the like can reliably be prevented.

By detecting the actual transition to a non-selected state of gate lines GL0-GLn, even when process variation or variations in an operating environment such as power supply voltage or temperature occurs, precisely the internal of display panel 1 is driven to a non-selected state and thereafter the next image data signal writing or writing of next image data may be performed. When transition of a non-select gate line to a non-selected state is detected to perform the operation related to image data writing to the next gate line, the operation start timing related to the next image data writing is set based on deactivation transition detect signal DIS. Thus, writing of the next pixel data signal can be performed at the optimum timing, a margin for writing can sufficiently be increased, and a writing timing for the next gate line of a pixel data signal can be advanced.

### First Embodiment

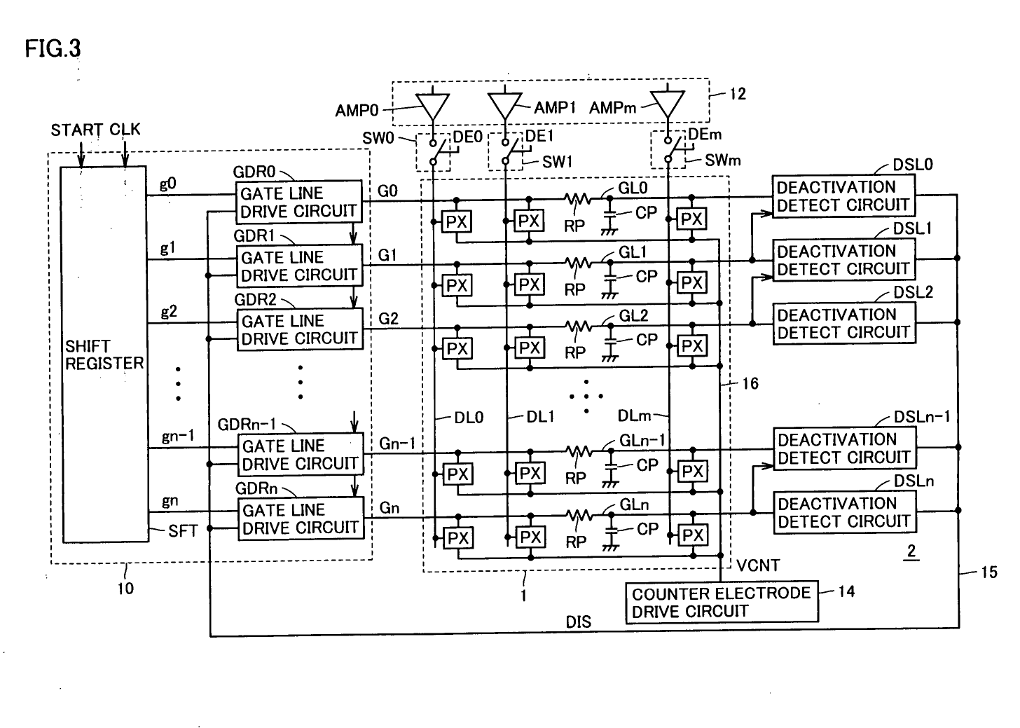

FIG. 3 schematically shows the configuration of a main part of the image display device according to the first embodiment of the present invention. In FIG. 3, display panel 1 includes a plurality of pixels PX arranged in rows and columns, gate lines GL0-GLn arranged corresponding to the rows of pixels PX, and data lines DL0-DLm arranged corresponding to the columns of pixels PX. Each of gate lines GL0-GLn has an increased line length with respect to its line width, and has an interconnection line (parasitic) resistance RP and parasitic capacitance CP. Parasitic resistance RP and parasitic capacitance CP exist for each of gate lines GL0-GLn in units of pixels PX. In FIG. 3, in order to simplify the figure, one unit parasitic resistance RP and unit parasitic capacitance CP are representatively shown in each of gate lines GL0-GLn.

A counter electrode 16 is provided in common to pixels PX. To the counter electrode 16, a counter electrode voltage VCNT from counter electrode drive circuit 14 is supplied. Counter electrode 16 is arranged opposing to display panel 1. In order to emphasize that the counter electrode voltage is supplied to each of the pixels in common, FIG. 3 shows that the counter electrode voltage is transmitted to each of pixels PX by a voltage line.

Deactivation transition detect circuit 2 shown in FIG. 1 includes deactivation detect circuits DSL0-DSLn provided corresponding to gate lines GL0-GLn, respectively. Deactivation detect circuits DSL0-DSLn drive the gate line deactivation transition detect signal DIS on signal line 15 to an active state, when respective gate lines GL0-GLn change from a selected state to a non-selected state and the next gate line in the scanning sequence is in a non-selected state. By providing deactivation detect circuits DSL0-DSLn corresponding to respective gate lines GL0-GLn, transition of individual gate lines GL0-GLn from a selected state to a non-selected state (from an active state to an inactive state) can precisely be detected. Further, by arranging deactivation detect circuits DSL0-DSLn at the terminating ends of gate lines GL0-GLn so as to detect the transition from a selected state to a non-selected state in a region where the signals change the latest, it can reliably be detected that each respective gate line is entirely driven to a non-selected state (an inactive state).

Image data write related circuit 3 shown in FIG. 1 includes a vertical scan circuit 10 for sequentially driving gate lines GL0-GLn to a selected state in a prescribed sequence, a data line drive circuit 12 for transmitting pixel data signals to data lines DL0-DLm according to an image data signal, and a counter electrode drive circuit 14 for generating counter electrode voltage VCNT.

Vertical scan circuit 10 includes a shift register SFT for sequentially driving basic gate signals g0-gn for selecting a gate line by sequentially shifting a start signal START in accordance with a clock signal CLK, and gate line drive circuits GDR0-GDRn provided corresponding to gate lines GL0-GLn, respectively, for transmitting gate signals GO-Gn to corresponding gate lines GL0-GLn, according to deactivation transition detect signal DIS and corresponding basic gate signals g0-gn.

Gate line drive circuits GDR1-GDRn maintain corresponding gate lines in a non-selected state during a first state in which gate line drive circuits GDR0-GDRn−1 of preceding stages in the scanning sequence are driving corresponding gate lines GL0-GLn−1 to a selected state. When deactivation transition detect signal DIS is activated and the gate line drive circuit of the preceding stage enters the second state, the next gate line drive circuit to be selected is allowed to transmit an active gate signal to the corresponding gate line.

Accordingly, when deactivation transition detect signal DIS indicates that a gate line in a selected state is driven to a non-selected state, gate line drive circuits GDR1-GDRn drive gate signals G1-Gn to a selected state in accordance with basic gate signals g1-gn, respectively.

Since gate line drive circuit GDR0 first drives gate signal G0 to a selected state according to start signal START in each vertical scanning cycle (1 frame), the problems of multiple selection and image data overwriting will not occur. Accordingly, this gate line drive circuit GDR0 generates gate signal G0 according to basic gate signal g0 from shift register SFT.

Data line drive circuit 12 includes amplifiers AMP0-AMPm provided corresponding to data lines DL0-DLm, respectively. These amplifiers AMP0-AMPm are coupled to data lines DL0-DLm through switch circuits SW0-SWm. For switch circuits SW0-SWm, in the case of a line sequential scheme, select signals DE0-DEm simultaneously attain an active state, and an image data signal is written in parallel to pixels PX connected to a selected gate line. In the case of the line sequential scheme, switch circuits SW0-SWm may not particularly be provided. In the case of a point sequential scheme, for pixels PX connected to a select gate line, select signals DE0-DEm are sequentially driven to a selected state according to a horizontal clock signal, not shown, whereby these switch circuits SW0-SWm are made conductive and pixel data signals are written sequentially. The image data signal writing may be performed according to either the line sequential scheme or the point sequential scheme. In FIG. 3, select signals DE0-DEm are shown being applied to switch circuits SW0-SWm, respectively.

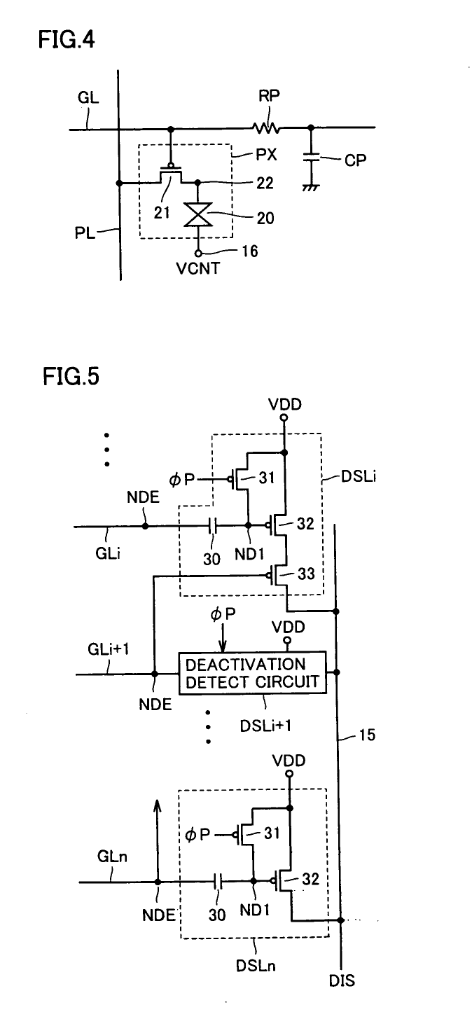

FIG. 4 shows one exemplary configuration of pixel PX shown in FIG. 3. In FIG. 4, pixel PX includes a display element 20 configured by a liquid crystal element connected between counter electrode 16 and internal node 22, and a transistor 21 electrically connecting internal node 22 to a corresponding data line DL (one of DL0-DLm) according to a gate signal on the corresponding gate line GL (one of GL0-GLn). On gate line GL, parasitic resistance RP and parasitic capacitance CP exist for each pixel PX.

When display element 20 is configured by a liquid crystal element, the orientation thereof is determined in accordance with the voltage difference between internal node 22 and counter electrode voltage VCNT applied to counter electrode 16, and in response, the transparency thereof is set. When a liquid crystal is employed as display element 20, a transistor may further be provided, which transmits a common electrode voltage VCOM to a transparent electrode (internal node 22) of the liquid crystal element through a capacitive element.

FIG. 5 shows the configuration of deactivation detect circuits DSL0-DSLn shown in FIG. 3. Deactivation detect circuits DSL0-DSLn−1 have the same configuration, and therefore, FIG. 5 shows a specific configuration of deactivation detect circuit DSLi (i=0 to n−1) and SDLn.

In FIG. 5, deactivation detect circuit DSLi includes a capacitive element 30 connected between an terminating end node NDE and node ND1 of gate line GLi, and a precharging P channel MOS transistor (insulating gate field effect transistor) 31 for precharging node ND1 to power supply voltage VDD level in accordance with a precharge instruct signal φP, and P channel MOS transistors 32 and 33 serially connected between a power supply node and deactivation transition detected signal line 15. MOS transistor 32 has its gate connected to node ND1, while MOS transistor 33 has its gate connected to terminating end node NDE of an adjacent gate line GLi+1. For the power supply node, power supply voltage VDD is supplied, and internal node ND1 is precharged to power supply voltage VDD level through MOS transistor 31 according to precharge instruct signal φP.

When gate line GLi is driven from an active state (a selected state) to an inactive state (a non-selected state), through capacitive coupling of capacitive element 30, the voltage level of node ND1 is decreased and MOS transistor 32 is set in a conductive state. Adjacent gate line GLi+1 is in a non-selected state, and MOS transistor 33 is in a conductive state, and therefore, deactivation transition detect signal line 15 is driven to power supply voltage VDD level. By using the capacitive element as a voltage-level-change detecting element, the change in the voltage level can be detected precisely without adversely affecting the potential of the gate line.

For the last gate line GLn in the vertical scanning sequence, there is no adjacent gate line to be selected in the next scanning. Accordingly, for deactivation detect circuit DSLn provided to this gate line GLn, MOS transistor 33 is not provided. According to the voltage level of node ND1, MOS transistor 32 drives deactivation transition detect signal line 15 to power supply voltage VDD level. However, in this deactivation detect circuit DSLn, MOS transistors 32 and 33 may be connected serially between the power supply node and deactivation transition detect signal line 15, with the gate of MOS transistor 33 being fixed to the ground voltage level.

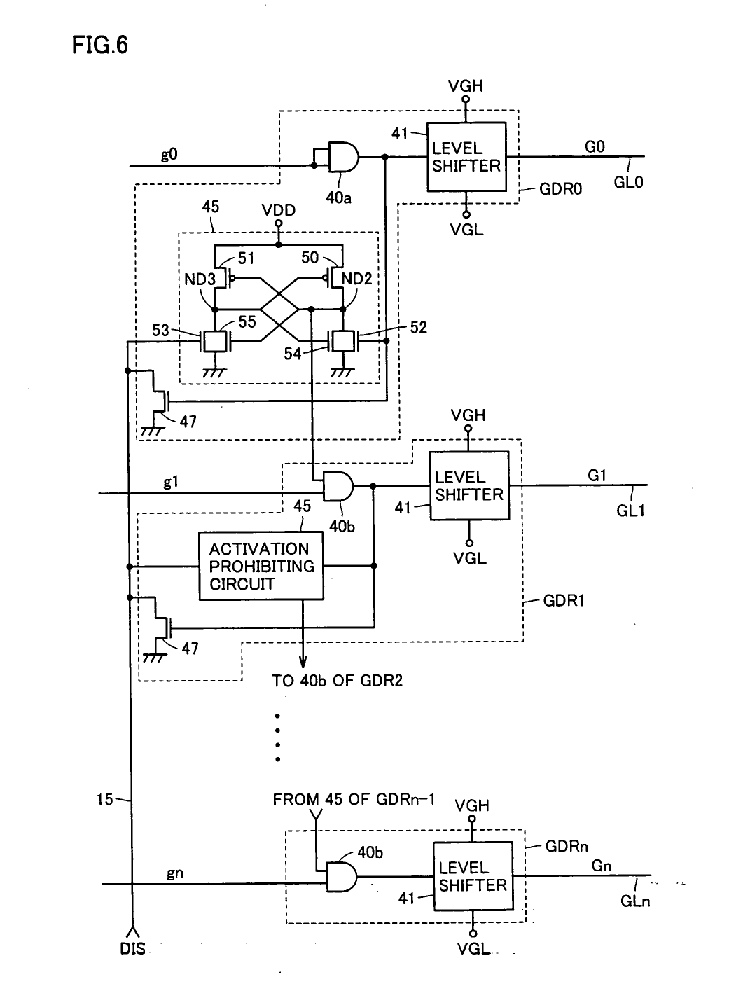

FIG. 6 shows the configuration of gate line drive circuits GDR0-GDRn shown in FIG. 3. For each of gate lines GL0 and GLn, an adjacent gate line exists only at one side thereof Accordingly, gate line drive circuits GDR0 and GDRn provided for these gate lines GL0 and GLn are made different in configuration from gate line drive circuits GDR 1to GDRn−1 provided for the other gate lines GL1 to GLn−1. Accordingly, in FIG. 6, the configuration of gate line drive circuits GDR0 and GDRn are shown specifically, and as for gate line drive circuits DGR1 to GDRn−1 provided for the other gate lines GL1 to GLn−1, gate line drive circuit GDR1 is representatively shown.

In FIG. 6, gate line drive circuit GDR0 includes AND gate 40a receiving basic gate signal g0 from a shifter at both inputs, a level shifter 41 converting the voltage level of a logical high level and a logical low level of a signal from AND gate 40a to voltage VGH and VGL to generate a gate signal G0, an activation prohibit circuit 45 being set in a first state (a selection prohibiting state of an adjacent gate line) according to an output signal of AND gate 40a as well as being set in a second state according to activation of deactivation transition detect signal DIS on deactivation transition detect signal line 15 for allowing generation (activation) of a gate signal of the next row, and N-channel MOS transistor 47 for precharging deactivation transition detect signal line 15 to ground voltage level in accordance with the output signal of AND gate 40a.

As for AND gate 40a, gate line GL0 is first driven to a selected state in a vertical scanning sequence of one frame (one screen), and is not associated with multiple selection problem in transition of gate signal G0 to a selected state. Therefore, AND gate 40a is supplied with basic gate signal g0 at both inputs.

MOS transistor 47 is conductive when the output signal of AND gate 40a is at H level, to fix deactivation transition detect signal line 15 to the ground voltage level. In deactivation of gate signal G0, the output signal of AND gate 40a attains L level, and MOS transistor 47 transits from a conductive state to a non-conductive state. After or concurrently with the transition of MOS transistor 47 to a non-conductive state, the farthest end of gate line GL0 (node NDE in FIG. 5) has the voltage level thereof decreased, and responsively deactivation transition detect signal DIS is driven to H level.

Activation prohibiting circuit 45 includes a P-channel MOS transistor 50 connected between a power supply node and node ND2 and having its gate connected to node ND3, a P-channel MOS transistor 51 connected between power supply node and node ND3 and having its gate connected to node ND2, an N-channel MOS transistor 52 connected between node ND2 and a ground node and receiving the output signal from AND gate 40a at its gate, an N-channel MOS transistor 53 connected between node ND3 and a ground node and having its gate connected to deactivation transition detect signal line 15, an N-channel MOS transistor 54 connected between node ND2 and a ground node and having its gate connected to node ND3, and an N-channel MOS transistor 55 connected between node ND3 and a ground node and having its gate connected to node ND2.

MOS transistors 54 and 55 are provided to prevent nodes ND2 and ND3 from entering a floating state when both of MOS transistors 52 and 53 enter a non-conductive state. Activation prohibiting circuit 45 is a latch circuit, and MOS transistors 54 and 55 are made to have current drivability sufficiently smaller than that of MOS transistors 52 and 53, in order not to adversely affect the state inversion of nodes ND2 and ND3. The adjustment of this current drivability is realized by adjusting the sizes (the ratio of the channel width and the channel length) or the on-resistance of the transistors. By employing a latch circuit for activation prohibiting circuit 45, when logic level of deactivation transition detect signal DIS changes, the latch state thereof can reliably be changed, to drive a gate signal to a selected state.

Gate line drive circuit GDR1 includes AND gate 40b receiving a signal on node ND2 of activation prohibiting circuit 45 of gate line drive circuit GDR0 and basic gate signal g1, a level shifter 41 performing voltage level conversion of an output signal of AND gate 40b to generate a gate signal G1, an activation prohibiting circuit 45 being set to a first state at activation (H level) of an output signal of AND gate 40b as well as being set to a second state at activation of deactivation transition detect signal DIS, and an N-channel MOS transistor 47 driving deactivation transition detect signal line 15 to ground voltage level according to an output signal of AND gate 40b.

Activation prohibiting circuit 45 included in gate line drive circuit GDR1 has the same configuration as that of activation prohibiting circuit 45 included in gate line drive circuit GDR0. A signal on node ND2 of activation prohibiting circuit 45 of gate line drive circuit GDR1 is applied to one input of AND gate 40b of gate line drive circuit GDR2 provided for a gate line of the next row. Gate line drive circuits having the same configuration as this gate line drive circuit GDR1 are provided for gate lines G1 to GLn−1.

Gate line drive circuit GDRn includes AND gate 40b receiving a signal on node ND2 of activation prohibiting circuit 45 of gate line drive circuit GDRn−1 of a preceding row and a basic gate signal gn, and a level shifter 41 for performing level conversion of an output signal of AND gate 40b to generate gate signal Gn. Level shifter 41 receives the high-side power supply voltage VGH and the low-side power supply voltage VGL. In the case where display element 20 shown in FIG. 4 is a liquid crystal element, in order to prevent degradation of element characteristics and occurrence of a flicker, AC driving is required. Thus, the polarity of counter voltage and the polarity of data signal are changed for each row. Accordingly, level shifter 41 is provided in order to reliably set the transistor (transistor 21 in FIG. 4) of a pixel to a non-conductive state and a conductive state in each of the gate lines.

Gate line GLn is the last gate line in the vertical scanning sequence, and when gate signal Gn on this gate line GLn is deactivated, a scanning for displaying the next image (frame) is performed, and according to a vertical synchronizing signal, gate line GL0 is selected as the first selected gate line for the next image. Accordingly, since there is a margin of time from deselection of gate line GLn to selection of gate line GL0 and the multiple selection problem at deactivation transition of gate line GLn will not occur, activation prohibiting circuit 45 and MOS transistor 47 for initializing the deactivation transition detect signal are not provided in this gate line drive circuit GDRn. Gate signal Gn is generated simply in accordance with an output signal of activation prohibiting circuit 45 for gate line drive circuit GDRn−1 in the preceding row and basic gate signal gn.

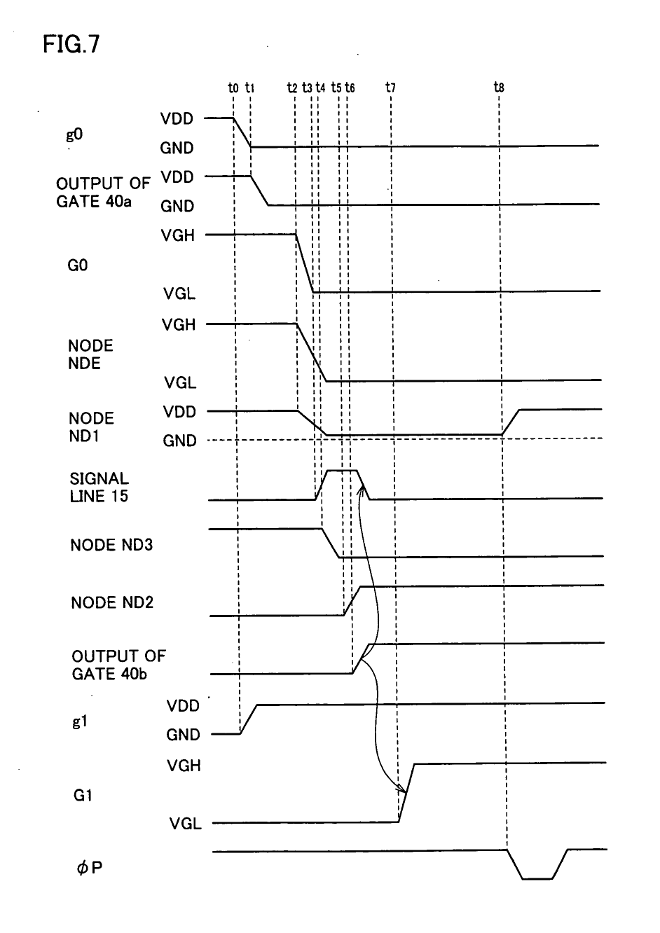

FIG. 7 is a signal waveform diagram representing the operation of the image display device shown in FIGS. 3-6. Now, referring to FIG. 7, the operation of the image display device shown in FIGS. 3-6 is described in the below. Here, in FIG. 7, the operation in which a gate signal on gate line GL0 of the 0-th row changes from a selected state to a non-selected state, and thereafter gate signal G1 on gate line GL1 of the first row changes from a non-selected state to a selected state is shown.

Shift register SFT shown in FIG. 3 performs a shifting operation according to clock signal CLK to drive its output signals sequentially to a selected state.

At time t0, basic gate signal g0 from shift register SFT shown in FIG. 3 changes from H level of power supply voltage VDD level to L level of ground voltage GND level. Concurrently, basic gate signal g1 for gate line GL1 of the first row from shift register SFT changes from L level of ground voltage level to H level of power supply voltage VDD level.

In accordance with the falling of basic gate signal g0, in gate line drive circuit GDR0, the output signal of AND gate 40a falls from H level to L level at time t1, with delay of its gate propagation delay. Here, gate signal G0 of the 0-th row is a signal first driven to a selected state in one vertical scanning sequence, and it is not necessary to prevent superposition with a gate signal for the gate line of the preceding row. Accordingly, both inputs of AND gate 40a are short-circuited, and in driving of gate line GL0 to a selected state, gate signal G0 is generated according to basic gate signal g0, independently of the state of deactivation transition detect signal DIS.

In accordance with the falling of the output signal of AND gate 40a in the gate line drive circuit GDR0, gate signal G0 output from level shifter 41 in gate line drive circuit GDR0 changes from high level voltage VGH level to low level voltage VGL at time t2 with elapse of its propagation delay.

MOS transistor 47 of gate line drive circuit GDR0 enters an on state in selection of gate line GL0, whereby deactivation detect signal line 15 is set to ground voltage level.

At terminating end node NDE of gate line GL0 also, the voltage level starts to change approximately simultaneously from time t2. However, this voltage changing speed is slower than at starting end due to the effect of parasitic resistance RP and parasitic capacitance CP. Even when gate signal G0 from level shifter 41 falls to low level voltage VGL at time t3, the voltage at terminating end node NDE of gate line GL0 still does not reach low level voltage VGL.

On the other hand, in accordance with the falling of the output signal AND gate 40a, in gate line drive circuit GDR0, MOS transistor 47 turns non-conductive.

In response to lowering in the voltage level of terminating end node NDE of gate line GL0, the voltage level of internal node ND1 lowers from power supply voltage VDD level through capacitive coupling of capacitive element 30 in deactivation detect circuit DSL0 shown in FIG. 5. As will be described later, this internal node ND1 is precharged to power supply voltage VDD level in advance. The amount of voltage drop of node ND1 is determined by a capacitance value of capacitive element 30, capacitance value of parasitic capacitance (not shown) of node ND1, and voltage change amount of terminating end node NDE (ΔVG=VGH−VGL). Here, the capacitance value of capacitive element 30 is set such that the voltage level of node ND1 decreases down to the voltage level that is sufficient for making MOS transistor 32 conductive.

At time t3, when the voltage level of node ND1 falls and MOS transistor 32 starts to be conductive in deactivation detect circuit DSL0, deactivation transition detect signal line 15 is charged through MOS transistors 32 and 33, and the voltage level thereof rises.

When the voltage level of the signal DIS on this signal line 15 in activation prohibiting circuit 45 becomes higher than the threshold voltage of MOS transistor 53, MOS transistor 53 turns conductive, and in gate line drive circuit GDR0, the voltage level of node ND3 starts to lower from time t4 and discharged to L level. When node ND3 reaches ground voltage level, in this gate line drive circuit GDR0, P-channel MOS transistor 50 of activation prohibiting circuit 45 turns conductive to charge node ND2, of which voltage level rises from time t5 up to power supply voltage VDD level. When this rising voltage level of node ND2 in gate line drive circuit GDR0 exceeds an input threshold voltage of AND gate 40b of gate line drive circuit GDR1 of the next row, an output signal of AND gate 40b in gate line drive circuit GDR1 rises to H level, and subsequently, at time t7, after a propagation delay of level shifter 41, gate signal G1 rises from the voltage VGL to the voltage VGH.

At time t6, basic gate signal g1 already attains H level at time t0, and the output signal of AND gate 40b rises with a delay from time t5 by the signal propagation delay of AND gate 40b.

Even when deactivation transition detect signal DIS on signal line 15 is driven to H level, if the output signal of AND gate 40b attains H level, MOS transistor 47 turns conductive in gate line drive circuit GDR1, and deactivation transition detect signal DIS on the signal line 15 is discharged to ground voltage level.

Accordingly, at time t7, when gate signal G1 from level shifter 41 of gate line drive circuit GDR1 rises to H level, terminating end node NDE of gate line GL0 has already been fallen to ground voltage level. Even when the level transition time of terminating end node NDE of the gate line increases due to the increase of parasitic resistance RP and parasitic capacitance CP affected by variations in manufacturing conditions, double selection of gate lines GL0 and GL1 will not occur since activation of next gate line GL1 will reliably be performed after the voltage level of terminating end node NDE of this gate line GL0 changes to the voltage VGL.

Specifically, after the voltage of terminating end node NDE of gate line GLj of the j-th row changes to the voltage VGL, gate line GLj+1 of the next (+1)-th row is activated automatically. Accordingly, the minimum gate line deactivation time can be set while preventing the double selection of pixels.

It should be noted that, when the output signal of AND gate 40b attains H level in gate line drive circuit GDR1, then corresponding MOS transistor 47 in this gate line drive circuit GDR1 turns conductive. In this state, since MOS transistors 32 and 33 are in a conductive state in deactivation detect circuit DSL0 provided for gate line GL0, a through current flows from power supply node VDD to ground node. However, since gate signal G1 attains the voltage VGH level at time t7, and from that time t7 the voltage level of terminating end node NDE of gate line G1 moderately increases, MOS transistor 33 enters a non-conductive state in transition deactivation detect circuit DSL0 provided for gate line GL0. Therefore, the time period in which this through current flows is a period between time t6 and time t7, and thus, current consumption can be made sufficiently small.

After gate signal G1 is driven to a selected state, at time t8, by precharge instruct signal φP having a prescribed pulse width of a negative polarity, node ND1 is charged to power supply voltage VDD level in each of deactivation detect circuits DSL0-DSLn.

As for a deactivation detect circuit provided for a non-selected gate line, as the associated gate signal maintains L level, internal node ND1 maintains the precharged power supply voltage VDD level, and the corresponding MOS transistor 32 maintains a non-conductive state. Accordingly, the deactivation detect circuit of a non-selected gate line does not adversely affect the deactivation transition detect operation.

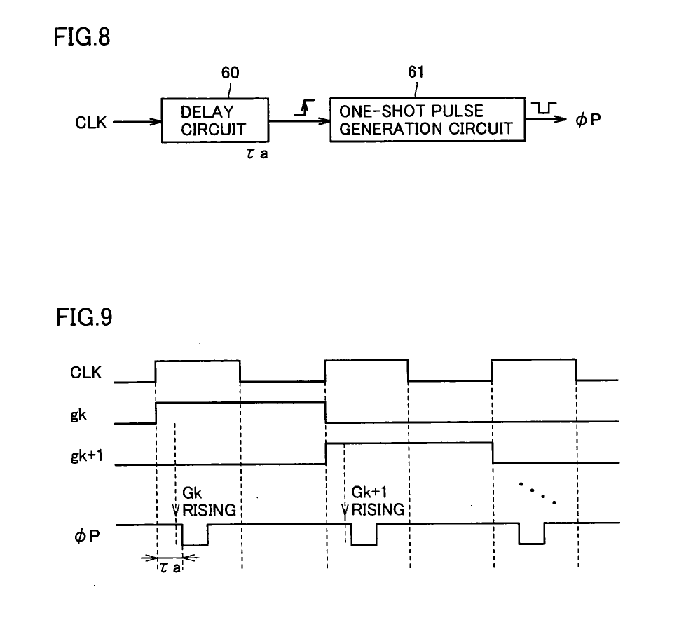

FIG. 8 shows one exemplary circuit configuration of a portion for generating precharge instruct signal φP to the deactivation detect circuits shown in FIG. 5. In FIG. 8, the precharge instruct signal generating portion includes a delay circuit 60 for delaying a clock signal CLK by a prescribed time τa, and a one-shot pulse generation circuit 61 for generating a one-shot pulse signal that is set to L level for a prescribed period in response to rising of an output signal of delay circuit 60. From this one-shot pulse generation circuit 61, precharge instruct signal φP is generated.

FIG. 9 is a timing diagram representing the operation of the precharge instruct signal generating portion shown in FIG. 8. Referring to FIG. 9, the operation of the precharge instruct signal generating portion shown in FIG. 8 will now be described.

The basic gate signal output from shift register SFT shown in FIG. 3 is shifted in synchronization with rising of clock signal CLK. In FIG. 9, as one example, a state is shown where basic gate signals gk and gk+1 are set to H level for one cycle period in each clock cycle. When basic gate signal gk attains H level in response to rising of this clock signal CLK, gate signal Gk rises in accordance with deactivation of a gate line of the preceding row. After this gate signal Gk rises, the output signal of delay circuit 60 attains H level, and in response, one-shot pulse generation circuit 61 generates precharge instruct signal φP. Similarly for basic gate signal gk+1, after corresponding gate signal Gk+1 rises, precharge instruct signal φP is set to L level for a prescribed period.

This delay time τa is only needed to be determined considering the maximum allowable propagation delay time of the gate line. Even when a precharge operation is performed when writing a pixel data signal in a gate line selected state, the gate line potential does not change and there will be no problem, since each gate line is in a selected state or in a non-selected state, and is in a state different from a floating state.

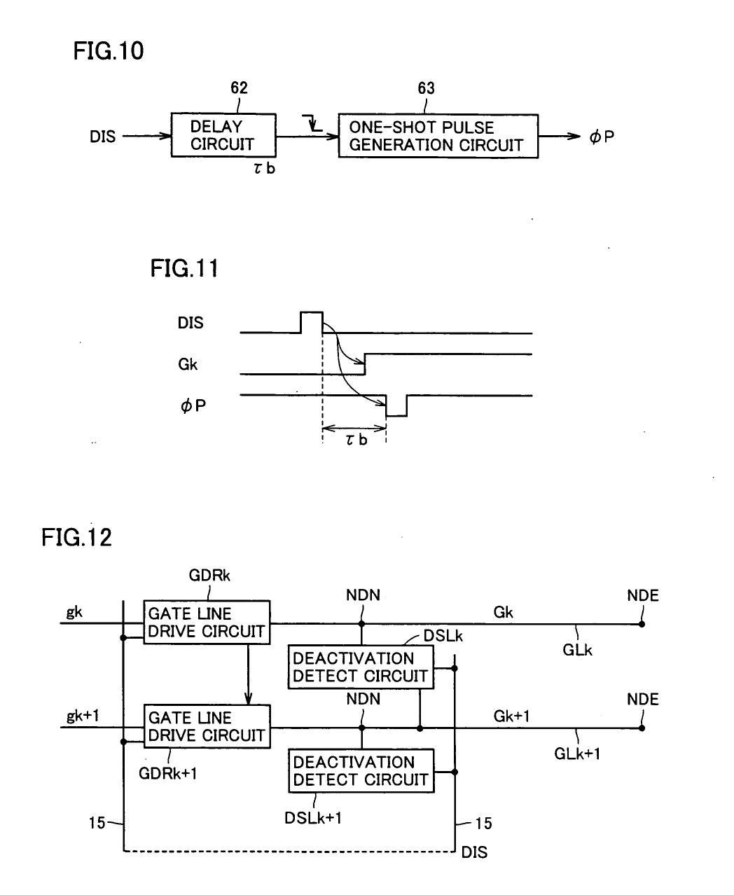

FIG. 10 shows another configuration of a portion for generating the precharge instruct signal. The precharge instruct signal generating portion shown in FIG. 10 includes a delay circuit 62 delaying deactivation transition detect signal DIS by a prescribed time τb, and a one-shot pulse generation circuit 63 for generating a pulse signal of one-shot in response to falling of an output signal of delay circuit 62. From this one-shot pulse generate circuit 63, a pulse signal turning L level for a prescribed time period is generated as precharge instruct signal φP.

In this configuration of the precharge instruct signal generating portion shown in FIG. 10, as shown in the operation waveform in FIG. 11, after deactivation transition detect signal DIS attains L level, and gate signal Gk for a gate line of the next row is driven, precharge instruct signal φP is activated according to the output signal of delay circuit 62. In this case, with reference to the time point at which deactivation transition detect signal DIS attains L level, the one-shot pulse signal is generated. The time interval between the activation of gate signal Gk and the falling of deactivation transition detect signal DIS can be obtained in advance by a gate propagation delay of AND gate 40a (or 40b) and of level shifter 41 in gate line drive circuit GDR. Thus, precharge instruct signal φP can be generated at the optimum timing.

Modification

FIG. 12 schematically shows the configuration of a main part of a modification of the first embodiment of the present invention. In FIG. 12, the configuration for gate lines GLk and GLk+1 is representatively shown. These gate lines GLk and GLk+1 are driven by gate line drive circuits GDRk and GDRk+1 according to basic gate signals gk and gk+1, respectively. Deactivation detect circuits DSLk and DSLk+1 are provided to gate signal input ends NDN of gate lines GLk and GLk+1, respectively. Specifically, in this modification, deactivation detect circuits DSLk and DSLk+1 are provided at the ends close to gate line drive circuits GDRk and GDRk+1 of gate lines GLk and GLk+1. Deactivation detect circuits DSLk and DSLk+1 both drive deactivation transition detect signal line 15, while gate line drive circuits GDRk and GDRk+1 transmit gate line signals Gk and Gk+1 to corresponding gate lines according to deactivation transition detect signal DIS, respectively.

Activation timings for deactivation detect circuits DSLk and DSLK+1 are set considering the signal propagation delays due to parasitic resistance and parasitic capacitance of gate lines GLk and GLk+1, respectively. Thus, at the time point at which the signal changes at terminating end nodes NDE of gate lines GLk and GLk+1, deactivation detect circuits DSLk and DSLk+1 are activated, and the transition of corresponding gate lines from a selected state to a non-selected state is detected. The actual circuit operation state is detected and accordingly a gate signal for the next row is driven to an active state. Thus, as compared to the case where a control signal independent of a circuit operation state such as the blanking signal or the like is used, the gate signal of the next row can be activated precisely depending on a non-selected/selected state of the gate line. Further, activation timing of a gate signal can be made sufficiently faster, by setting the timing with a margin for a signal propagation delay considered.

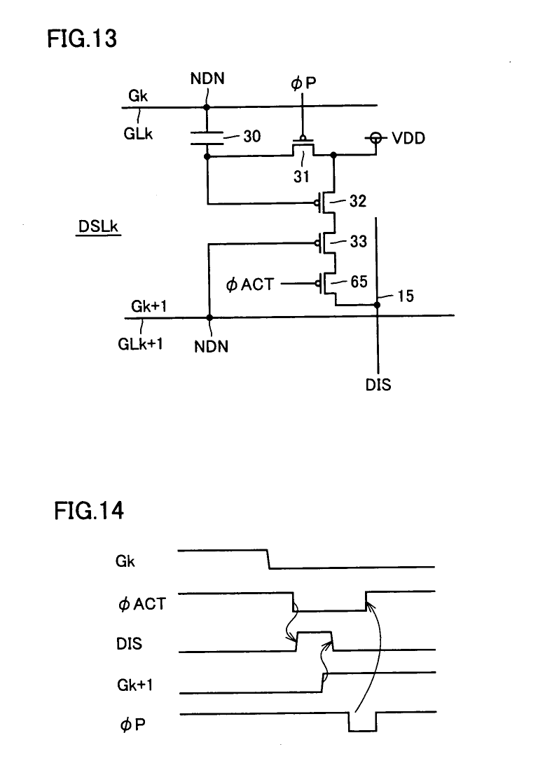

FIG. 13 shows one exemplary configuration of deactivation detect circuit shown in FIG. 12. In FIG. 13, the configuration of deactivation detect circuit DSLk is representatively shown. Deactivation detect circuit DSLk shown in FIG. 13 is different from deactivation detect circuit DSLi shown in FIG. 5 in the following points. Specifically, between P channel MOS transistor 33 receiving signal Gk+1 of input end node NDN of adjacent gate line GLk+1 at its gate and deactivation transition detect signal line 15, there is provided a P-channel MOS transistor 65 that is rendered selectively conductive in response to activation control signal φACT. With a signal propagation delay time in gate lines GLk and GLk+1 considered, activation control signal φACT is activated after activation of the gate line in each gate line drive cycle. The other configuration of deactivation detect circuit DSLk shown in FIG. 13 is the same as that of deactivation detect circuit DSLi shown in FIG. 5, and therefore corresponding parts are denoted by the same reference numerals, and detailed description thereof is not repeated.

It is noted that MOS transistor 33 is not provided in deactivation detect circuit DSLn for the last gate line GLn in the vertical scanning sequence.

FIG. 14 is a signal waveform diagram representing the operation of deactivation detect circuit DSLk shown in FIG. 13. Now, with reference to FIG. 14, the operation of deactivation detect circuit DSLk shown in FIG. 13 is described.

In synchronization with rising of a not shown clock signal (CLK), gate signal Gk from the level shifter falls from H level to L level after elapse of a prescribed gate propagation delay. After elapse of a prescribed time since the falling of gate signal Gk, activation control signal φACT attains L level, and MOS transistor 65 turns conductive. As gate signal Gk has fallen to L level, and gate signal Gk+1 on gate line GLk+1 is at L level at this time, deactivation transition detect signal DIS on deactivation transition detect signal line 15 attains H level. In response, in gate line drive circuit GDRk+1 shown in FIG. 12, the state of the internal activation prohibiting circuit changes, and gate signal Gk+1 attains H level according to basic gate signal gk+1. When gate signal Gk+1 rises to H level, deactivation transition detect signal DIS falls to L level by gate line drive circuit GDRk+1.

After a prescribed time elapses, precharge instruct signal φP is activated for a prescribed period, and activation control signal φACT attains H level in accordance with precharge instruct signal φP. As MOS transistor 33 is already in a non-conductive state according to gate signal Gk+1 upon activation of precharge instruct signal φP, no problem will occur even if MOS transistor 65 is in a conductive state.

As shown in FIGS. 12 and 13, even when detection of transition to deactivation of a gate signal is performed at gate signal input end node NDN of a gate line, if the deactivation transition detection operation is activated with the signal propagation delay on the gate line. Consequently, even if the propagation delay of the gate line varies due to process variation, to cause a waveform rounding in the gate signal, the gate signal for the next row can be precisely driven to the selected state after the gate signal for the preceding row is deactivated.

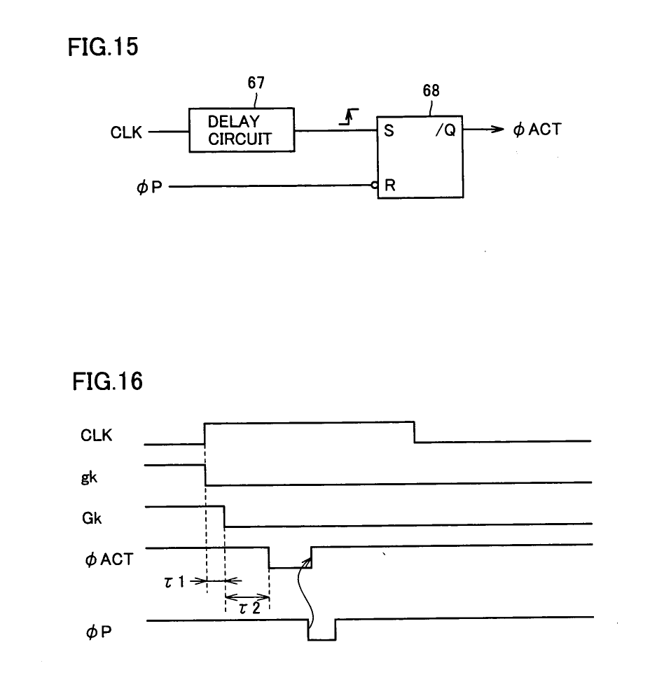

FIG. 15 shows one exemplary configuration of a portion for generating the activation control signal φACT shown in FIG. 13. In FIG. 15, activation control signal generating portion includes a delay circuit 67 for delaying clock signal CLK by a prescribed time, and set/reset flip-flop 68 being set in response to rising of an output signal of delay circuit 67 and being reset in response to falling of precharge instruct signal φP. Activation control signal φACT is output from an output/Q of set/reset flip-flop 68.

FIG. 16 is a signal waveform diagram representing the operation of the activation control signal generating portion shown in FIG. 15. Now, with reference to FIG. 16, the operation of the activation control signal generating portion shown in FIG. 15 is described.

When clock signal CLK rises to H level, basic gate signal gk falls to L level, and after a prescribed time (gate propagation delay time) τ1 elapses, gate signal Gk falls to L level. After delay time τ2 for taking into-account the signal propagation delay of the gate line elapses, an output signal of delay circuit 67 rises to H level, set/reset flip-flop 68 is set, and activation control signal φACT attains L level. When the set time period elapses and precharge instruct signal φP is activated, set/reset flip-flop 68 is reset, and activation control signal φACT attains H level.

Accordingly, when clock signal CLK rises to H level and a scanning cycle for pixels of the next gate line starts, activation control signal φACT is made active considering the signal propagation delay of the gate line, to reliably prevent the multiple selection of gate lines. Specifically, when rising/falling characteristics of the signal of each gate line are equal to each other, even when deactivation of this gate signal is detected to immediately activate the gate signal for the gate line of the next row while the terminating end of the gate line of the preceding (current) row is in a selected state, it is considered that transition of the preceding row to a non-selected state and the transition of the next row to a selected state are transmitted in the same direction with the same propagation characteristics. Accordingly, when the terminating end of the gate line of the next row is driven to a selected state, the terminating end of the gate line of the preceding row has been transited to a non-selected state. Therefore, the multiple selection state of selected states over the entire gate lines can be prevented.

The gate propagation delay time in set/reset flip-flop 68 may not necessarily be considered so long as it is at the same order as the gate propagation delay for the clock signal of the shift stage in the shift register generating basic gate signal gk. Activation timing of activation control signal φACT is set simply considering gate propagation delay time in the gate line drive circuit and signal propagation delay time over the entire gate line. In this case, when the signal rising and falling characteristics of the gate line are equal to each other as described above, it is not necessary to activate activation control signal φACT with the propagation delay time of the gate line from falling of gate signal Gk further considered, and the gate line for the next row may be driven to a selected state immediately when deactivation of the gate signal is detected.

As described above, according to the first embodiment of the present invention, after detecting the transition of a gate line to a non-selected state, a gate signal for the next row is driven to a selected state. Thus, multiple selection of gate lines can be prevented even when manufacturing processes and operating environment changes, the circuit operation timing can be optimized, and the operating margin can be increased.

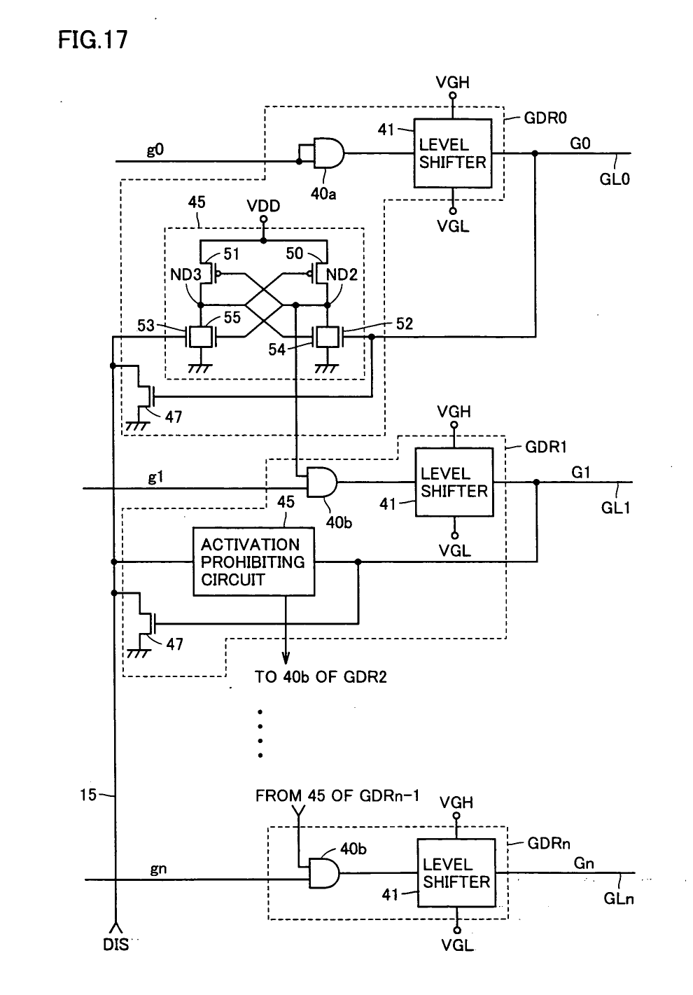

Second Embodiment FIG. 17 schematically shows the configuration of a main part of an image display device according to the second embodiment of the present invention. In the configuration shown in FIG. 17, for a signal applied to activation prohibiting circuit 45 in the gate line drive circuit, a signal transmitted from level shifter 41 to a corresponding gate line GL (GL0-GLn−1) is used in place of output signals of AND gates 40a and 40b. The configuration of gate line drive circuit GDR (GDR0-GDRn) shown in FIG. 17 is the same as that of FIG. 6 and therefore corresponding parts are denoted by the same reference characters, and detailed description thereof will not be repeated.

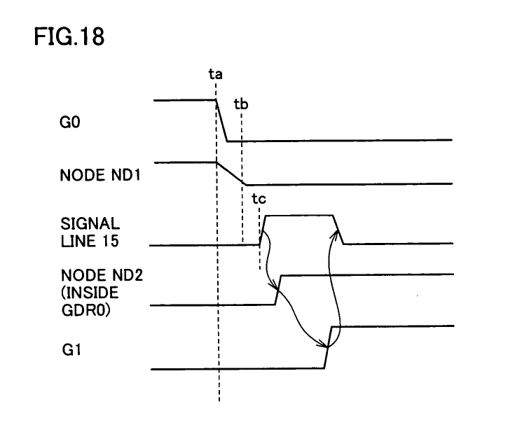

FIG. 18 is a signal waveform diagram representing the operation of the gate line drive circuit shown in FIG. 17. FIG. 18 shows operation signal waveforms in the case when gate signal G0 is deactivated and subsequently gate signal G1 is driven to an active state.

At time ta, gate signal G0 from gate line drive circuit GDR0 falls to L level. Before time ta, MOS transistor 52 of activation prohibiting circuit 45 is in a conductive state in gate line-drive circuit GDR0, and node ND2 is at L level. MOS transistor 47 is in a conductive state, and deactivation transition detect signal line 15 is at L level. In accordance with falling of gate signal G0, the voltage level of node ND1 moderately decreases through the capacitive coupling of the capacitive element in deactivation detect circuit DSL0 (see FIG. 5) provided at the terminating end of gate line GL0.

At time tb, the voltage level of node ND1 of deactivation detect circuit DSL0 (see FIG. 5) provided for gate line GL0 lowers. Even if current is supplied to deactivation transition detect signal line 15 at this time, since MOS transistors 47 and 52 do not fully turn non−conductive in gate line drive circuit GDR0, deactivation transition detect signal DIS of signal line 15 maintains L level (or rises moderately).

At time tc, when MOS transistors 47 and 52 fully turn non-conductive in accordance with gate signal G0, deactivation transition detect signal DIS on signal line 15 is driven to H level by corresponding deactivation detect circuit GSL0 (see FIG. 5). In response, MOS transistor 53 turns conductive in this gate line drive circuit GDR0, node ND3 is discharged to ground voltage level, and node ND2 is driven to power supply voltage level. When this node ND2 is driven to power supply voltage level, an output signal of AND gate 40b attains H level in gate line drive circuit GDR1 of the next row, and after a prescribed propagation delay time elapses, gate signal G1 attains H level. When gate signal G1 attains H level, MOS transistor 47 in gate line drive circuit GDR1 turns conductive, and deactivation transition detect signal line 15 is discharged to ground voltage level.

Accordingly, by using the gate signal transmitted from level shifter 41 to the gate line as a drive signal for activation prohibiting circuit 45, the detection operation starting timing of the signal on deactivation transition detect signal line 15 can be delayed. Hence, the changing timing of the output signal of activation prohibiting circuit 45 can be delayed as compared to the case in which AND gates 40a and 40b shown in FIG. 5 are used. Thus, activation of the gate signal of the next row can be delayed, increasing a margin for the time required for preventing gate line multiple selection. Thus, double selection of gate lines can reliably be prevented independently of process variations and variations in the operating environment.

As described above, according to the second embodiment of the present invention, the gate signal from the level shifter is applied, as a driving signal to the activation prohibiting circuit that adjusts the gate line driving timing of the next row in accordance with deactivation transition detection of the gate line. Thus, the generation timing of the gate signal for the gate line of the next row can be delayed, and double selection of the gate lines can reliably be prevented.

### Third Embodiment

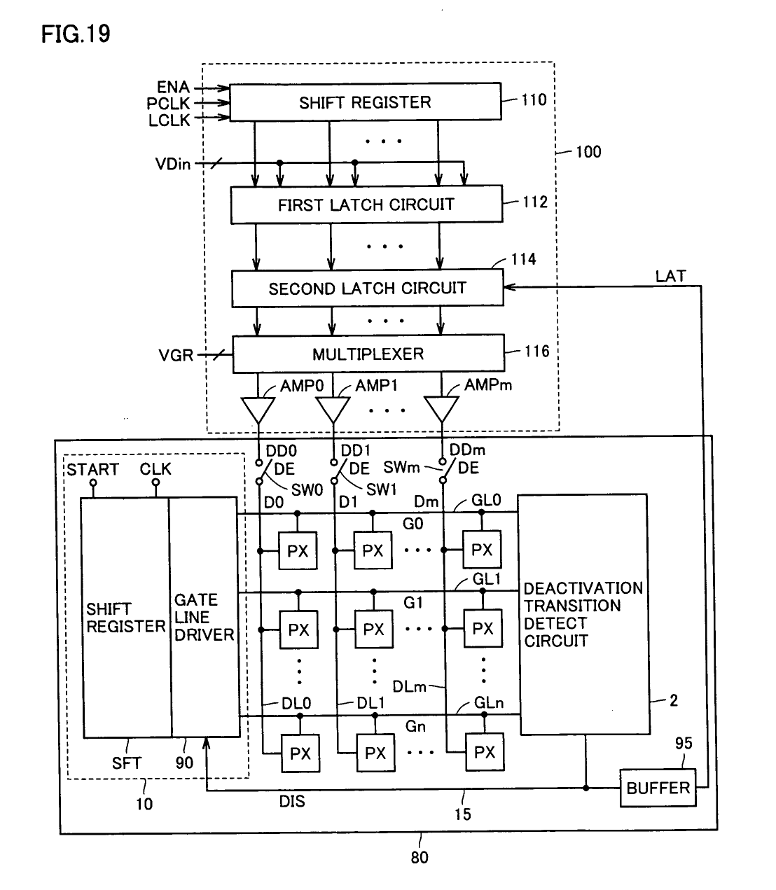

FIG. 19 schematically shows the overall configuration of an image display device according to the third embodiment of the present invention. In FIG. 19, the image display device includes a display device 80 displaying an image according to an image data signal, and DA conversion circuit 100 for generating the image data signal for display device 80. Display device 80 includes, as shown in the first and second embodiments, pixels PX arranged in rows and columns, a deactivation transition detect circuit 2 detecting transition of a gate signal on gate lines GL0-GLn to an inactive state, and a vertical scan circuit 10 sequentially scanning the gate liens GL0-GLn. Vertical scan circuit 10 includes a shift register SFT sequentially shifting a start signal START according to a clock signal CLK to generate a basic gate signal, and a gate line driver 90 sequentially driving the gate lines GL0-GLn to a selected state in accordance with the basic gate signal from the shift register SFT and deactivation transition detect signal DIS.

Gate line driver 90 includes gate line drive circuits GDR0-GDRn arranged corresponding to gate lines GL0-GLn, respectively. Deactivation transition detect circuit 2 has the same configuration as that shown in FIG. 5, and includes a deactivation detect circuit provided for each of gate lines GL0-GLn.

In this display device 80, a buffer circuit 95, which buffers and outputs an output signal of deactivation transition detect circuit 2, is further provided for setting the data output timing of DA conversion circuit 100 according to an output signal of deactivation transition detect circuit 2. Buffer circuit 95 is provided for providing drivability to a signal on deactivation transition detect signal line 15 to be transmitted to DA conversion circuit 100 provided outside of the display device. When the drivability of deactivation transition detect signal DIS on the signal line 15 is adequately large, it is not particularly necessary to provide buffer circuit 95.

DA conversion circuit 100 includes a shift register 110 performing a shifting operation according to a pixel clock signal PCLK when an enable signal ENA is active and being reset according to a line clock signal CLK, a first latch circuit 112 sequentially taking in and latching multi-bit image data VD in accordance with an output signal of shift register 110, a second latch circuit 114 latching and outputting the latched data of first latch circuit 112 according to a latch instruct signal LAT from buffer circuit 95, a multiplexer 116 selecting corresponding gradation voltages from a plurality of gradation voltages according to the image data from second latch circuit 114, and amplifiers AMP0-AMPm generating analog image data signals DD0-DDn according to the gradation voltages from multiplexer 116.

Output image data signals DD0-DDn of amplifiers AMP0-AMPm are transmitted to data lines DL0-DLm through switch circuits SW0-SWm, respectively. Switch circuits SW0-SWm simultaneously enter a conductive state when image data signals are written in the line sequential scheme. Alternatively, when image data signals are written according to the point sequential scheme, switch circuits SW0-SWm are sequentially set to a conductive state, or may not be provided.

Shift register 110 includes register circuits corresponding to pixels PX of one row in display device 80, or to data lines DL0-DLm, respectively, and sequentially performs a shifting operation according to pixel data clock signal PCLK to drive one of the outputs to a selected state. Shift register 110 generates a not shown enable signal when the shifting operation for the pixels of one row is completed, and returns to an initial state according to line clock signal LCLK that is applied in response to the enable signal.

First latch circuit 112 includes latches provided corresponding to data lines DL0-DLm of display device 80, respectively, and sequentially driven to a selected state according to an output signal of shift register 110 to take in and latch the received multi-bit image data VDin.

Similarly, second latch circuit 114 includes latches provided corresponding to data lines DL0-DLm, respectively. These latches have retaining contents reset in response to rising of latch instruct signal LAT, and take in and latch and output the latched output of first latch circuit 112 in response to falling of latch instruct signal LAT.

Gradation voltage VGR is a reference voltage of a plurality of kinds or levels, and contains the voltages for converting digital image data VDin to an analog signal. Specifically, multiplexer 116 includes decode circuits arranged corresponding to data lines DL0-DLm, respectively, and selects and outputs a gradation voltage that corresponds to the digital image data output from each latch of second latch circuit 114.

Amplifiers AMP0-AMPm operate in a voltage follower mode, and drive data lines DL0-DLn at high speed and with low impedance, in accordance with the gradation voltages generated by multiplexer 116. By the selection of gradation voltages VGR in multiplexer 116, the digital image data for each pixel is converted into an analog signal.

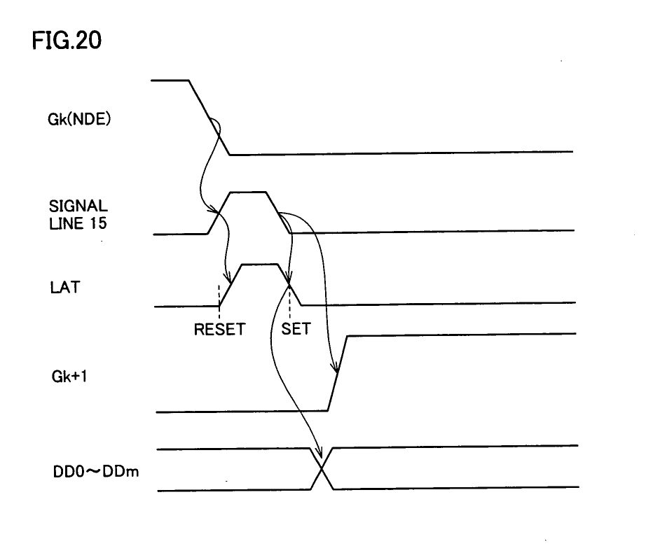

FIG. 20 is a signal waveform diagram representing the operation of the image display device shown in FIG. 19. Now, referring to FIG. 20, the operation of the image display device shown in FIG. 19 in switching of gate lines is described. In FIG. 20, operational waveforms are shown for the case when gate line GLk is driven from a selected state to a non-selected state, and subsequently gate line GLk+1 is driven to a selected state.

When a scanning period for gate line GLk is completed, gate line driver 90 drives gate signal Gk to a non-select signal. In accordance with the deactivation of the gate signal from gate line driver 90, gate signal Gk moderately falls to L level on terminating end node NDE of gate line GLk. In accordance with the falling of gate signal Gk, deactivation transition detect circuit 2 drives deactivation transition detect signal line 15 to H level. In accordance with the rising of a signal on deactivation transition detect signal line 15, latch instruct signal LAT from buffer 90 rises to H level.

In DA conversion circuit 100, when gate line Gk is driven, shift register 110 is performing a shifting operation, and digital image data VDin for gate line Gk+1 of the next row is stored for each pixel in first latch circuit 112. In response to the rising of latch instruct signal LAT, second latch circuit 114 is reset, and the image data for each pixel of gate line Gk stored therein is reset. Subsequently, in response to falling of latch instruct signal LAT, second latch circuit 114 is set to a set state, and second latch circuit 114 takes in and latches the digital image data output from first latch circuit 112.

In accordance with pixel data outputted from second latch circuit 114, multiplexer 116 performs the gradation voltage selection operation, and then gradation voltages corresponding to the respective pixel data are selected and transmitted to amplifiers AMP0-AMPm. Amplifiers AMP0-AMPm are voltage followers, and transmit analog pixel data signals DD0-DDm to corresponding data lines DL0-DLm, respectively, according to the line sequential scheme or the point sequential scheme.

When deactivation transition detect signal DIS on signal line 15 falls to L level, gate signal Gk+1 from the gate line drive circuit provided for gate line Gk+1 is driven to H level after a propagation delay time intrinsic to the circuit. Even when the delay time period from the latching operation of second latch circuit 114 to the selecting operation in multiplexer 116 and the delay times in amplifiers AMP0-AMPm are different in DA conversion circuit 110, gate line GLk in a selected state is driven to a non-selected state and thereafter new pixel data signals for the next row are generated and transmitted to date lines DL0-DLm. Therefore, overwriting to the pixels by the pixel data signals of the next write cycle being transmitted in the previous write cycle can be prevented.

Since the gate signal in display device 80 and the latch timing signal for second latch circuit 114 are set according to the gate line driven to a non-selected state in display device 80, it is not necessary to consider the operating environment such as power supply voltage and operating temperature and a signal propagation delay of the gate line, erroneous writing to pixels connected to the gate line of a previous cycle can automatically be prevented, and optimization of a timing such as gate line activation can easily be implemented. Additionally, an output timing of pixel data from DA conversion circuit 100 and a selection timing of the gate line can be optimized, and a write timing margin of pixel data can be increased.

It is noted that, in the image display device shown in FIG. 19, DA conversion circuit 100 is provided outside the display device 80 (formed on another chip). However, DA conversion circuit 100 may be arranged in display device 80.

As described above, according to the third embodiment of the present invention, deactivation transition of a gate line is detected, and based on the detection result, generating timing of each pixel data signal for the next cycle is set. Accordingly, an image display device can be implemented, which can automatically prevent overwriting of pixel data, drive the gate lines and the data lines at optimum timing, to increase a write margin, for performing image data writing precisely.

### Fourth Embodiment

When a display element included in a pixel is a liquid crystal element, the characteristic thereof is degraded if DC (direct current) voltage is applied across the liquid crystal element. Therefore, AC driving is normally performed for such liquid crystal element. Specifically, the writing and voltage retention for a unit color pixel is performed by writing voltages of positive and negative polarities with respect to the counter electrode voltage to a data line alternately for each frame.

When the frame frequency is 60 Hz and 60 frames are displayed per second, if the polarity of a data signal is inverted every frame, then the liquid crystal drive frequency normally attains 30 Hz. In such a case of liquid crystal drive frequency of 30 Hz, unsteady blinking referred to as flicker appears on the display screen, degrading the displayed image quality. In order to suppress such a flicker, such an approach is generally employed to alternately invert the polarity of liquid crystal drive voltage every vertically and horizontally adjacent pixels. Accordingly, the counter electrode voltage has its polarity changed for each gate line scanning cycle (gate line activation cycle), to prevent generation of the flicker by inverting the polarity of the signal voltage between adjacent rows.

In the case of such AC driving, when the counter electrode voltage does not change after a selected gate line is driven to an inactive state, the voltage difference between a pixel node (node 22 in FIG. 4) and the counter electrode on this select gate line becomes inaccurate, resulting in erroneous display. Accordingly, in the fourth embodiment, the counter electrode voltage polarity is changed based on the detection result of the deactivation transition detect circuit.

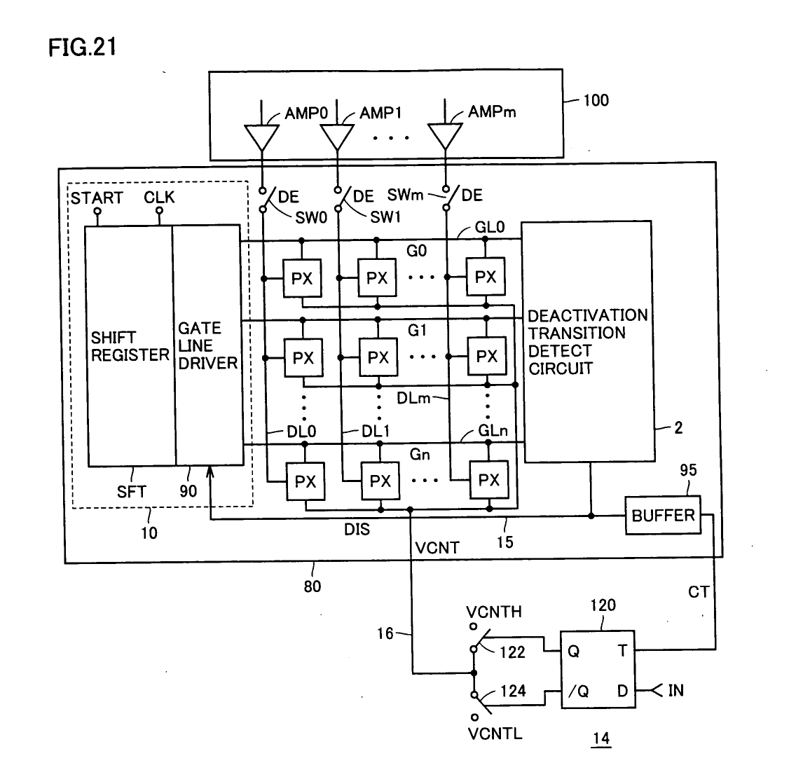

FIG. 21 schematically shows the overall configuration of an image display device according to the fourth embodiment of the present invention. In FIG. 21, display device 80 is the same in configuration as display device 80 shown in FIG. 19. In order to transmit write data to data lines DL0-DLm of display device 80, DA conversion circuit 100 is provided. DA conversion circuit 100 may have the same configuration as the configuration shown in FIG. 19 or as a conventional configuration.

Outside display device 80, counter electrode drive circuit 14 shown in FIG. 3 is provided. Counter electrode drive circuit 14 has a latch circuit 120 taking in a signal IN applied to its input D according to an output signal CT of buffer circuit 95, a switch gate 122 rendered selectively conductive according to an output signal of output Q of latch circuit 120 and transmitting high-side counter electrode voltage VCNTH to counter electrode 16 when made conductive, and a switch gate 124 rendered selectively conductive according an output signal of output/Q of latch circuit 120 and transmitting low-side counter electrode voltage VCNTL to counter electrode line 16 when made conductive.

Input signal IN has a doubled cycle of the driving cycle of the gate lines. Latch circuit 120 takes in and outputs input signal IN applied to input D according to rising of output signal CT of buffer circuit 95. Switch gates 122 and 124 enter a conductive state when outputs Q and/Q of latch circuit 120 is at H level, respectively. Accordingly, switch gate 122 and 124 are complementarily set to a conductive state.

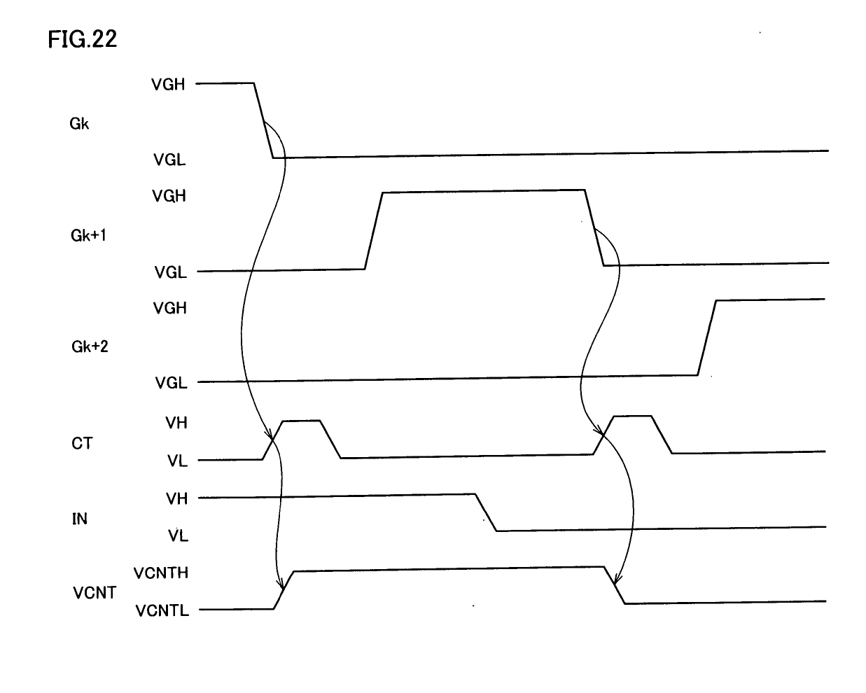

FIG. 22 is a signal waveform diagram representing an operation of counter electrode drive circuit 14 of the image display device shown in FIG. 21. Now, referring to FIG. 22, the operation of changing counter electrode voltage of the image display device shown in FIG. 21 is described. A gate signal shows a signal waveform at the terminating end of a gate line.

Now, it is assumed that gate line GLk is in a selected state, and counter electrode voltage VCNT is at low-side counter electrode voltage VCNTL. When gate signal Gk on gate line GLk falls from high level voltage VGH to low level voltage VGL, deactivation transition detect circuit 2 detects the deactivation of gate line Gk, and drives deactivation transition detect signal DIS on signal line 15 to H level. In response, the signal CT from buffer circuit 95 attains H level (voltage VH level), and latch circuit 120 outputs a signal of H level from output Q according to the currently applied input signal IN of H level (voltage VH level). In response, switch gate 122 turns conductive, and transmits high-side counter electrode voltage VCNTH to counter electrode 16. Switch gate 124 enters non-conductive state according to the low level signal from output/Q of latch circuit 120.

When the output signal DIS of deactivation transition detect circuit 2, or the output signal CT of buffer circuit 95 attains L level, gate signal Gk+1 for the gate line of the next row attains the high level of voltage VGH level. Writing operation of an image data signal to pixels of this gate line GLk+1 is performed. In a time period in which gate signal Gk+1 is in an active state, input signal IN changes from high level voltage VH to low level voltage VL.

When gate signal Gk+1 falls from high level voltage VGH to low level voltage VGL, the signal CT from buffer circuit 95 rises from low level voltage VL to high level voltage VH, and in response to the rising of the signal CT, latch circuit 95 takes in input signal IN and outputs a signal corresponding to thus taken signal from output Q. In this case, since input signal IN is at a low level, the signal from output Q of latch circuit 120 attains the low level, switch gate 122 enters a non-conductive state, switch gate 124 enters a conductive state, and low-side counter electrode voltage VCNTL is transmitted to counter electrode 16. Subsequently, the voltage level of this counter electrode voltage VCNT is switched for each gate line drive cycle.

Accordingly, since the voltage level of the counter electrode voltage is changed after the gate line in a selected state is fully driven to a non-selected state, an image can be displayed precisely. Additionally, the timing for changing the voltage level of the counter electrode voltage is automatically set according to deactivation of the gate line in a selected state in an actual operation. Accordingly, designing of the timing of changing the counter electrode voltage is facilitated, and a margin for the counter electrode voltage changing timing can be increased.

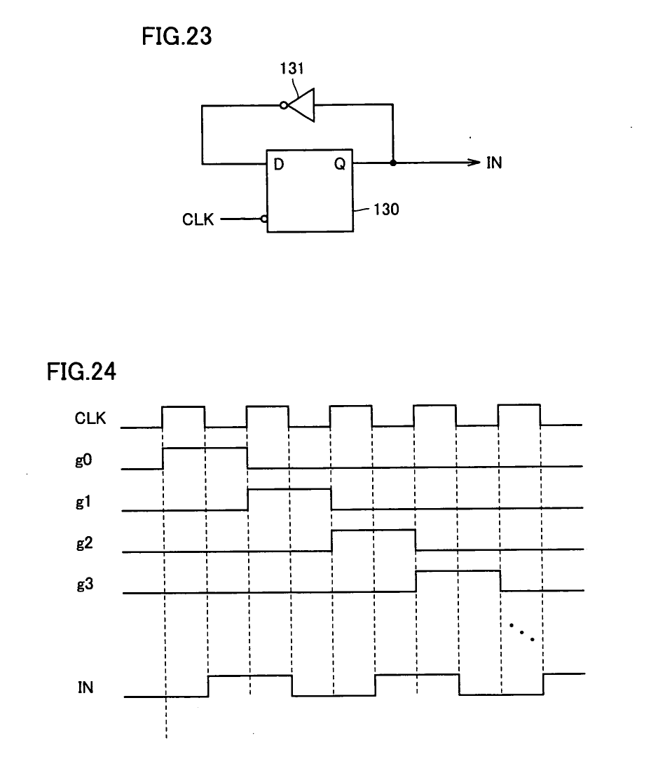

FIG. 23 shows an exemplary configuration of a portion for generating input signal IN. In FIG. 23, the portion for generating the input signal IN includes an inverter 131 inverting input signal IN and D flip-flop 130 taking in and latching an output signal of inverter 131 in response to falling of clock signal CLK and generating input signal IN from its output Q.

FIG. 24 is a timing diagram representing the operation of the input signal generating portion shown in FIG. 23. Now, referring to FIG. 24, the operation of the input signal generating portion shown in FIG. 23 is described.

Clock signal CLK is the same clock signal as clock signal CLK supplied to the shift register for the vertical scanning. Accordingly, synchronously with rising of clock signal CLK, basic gate signals g0, g1, g2, g3 . . . , are sequentially driven to a selected state. These basic signals g0 and the others are maintained in an active state (selected state) for one cycle period of clock signal CLK.

Assuming that input signal IN is first set at L level, the output signal of inverter 131 is at H level. When clock signal CLK falls, the output signal from output Q of D flip-flop 130 attains the logic level corresponding to the output signal of inverter 131, and input signal IN attains H level. Subsequently, the logic level of input signal IN changes every falling of clock signal CLK.

It is noted that, in the configuration described above, the output signal from complemental output/Q of D flip-flop 130 may be used in place of the output signal of inverter 131.

Further, as a circuit configuration for generating the input signal IN, a T flip-flop may be utilized and an inverted clock of clock signal CLK may be applied to the clock input of the T flip-flop.

Counter electrode drive circuit 14 may be provided inside the display device.

Further, similarly to the configuration shown in the third prior art document, counter electrode 16 may be divided corresponding to each of gate lines, and the levels of counter electrode voltages may be changed in units of divided counter electrode lines. In the configuration of the third prior art document, at gate line input end, a toggle flip-flop (T flip-flop) and a switch gate is arranged corresponding to each divided counter electrode line and the toggle flip-flop is driven according to a corresponding gate signal. According to such configuration, the voltage level of the corresponding divided counter electrode line can be changed when the corresponding gate line is driven to a selected state. Setting/resetting of the toggle flip-flops may be performed to the divided electrode lines in common.

As described above, according to the fourth embodiment of the present invention, it is configured that the voltage level of the counter electrode voltage is changed after the selected gate line enters a non-selected state. Accordingly, designing of the timing for changing the counter electrode voltage is facilitated, and a margin of the counter electrode voltage changing timing can be increased.

### Fifth Embodiment

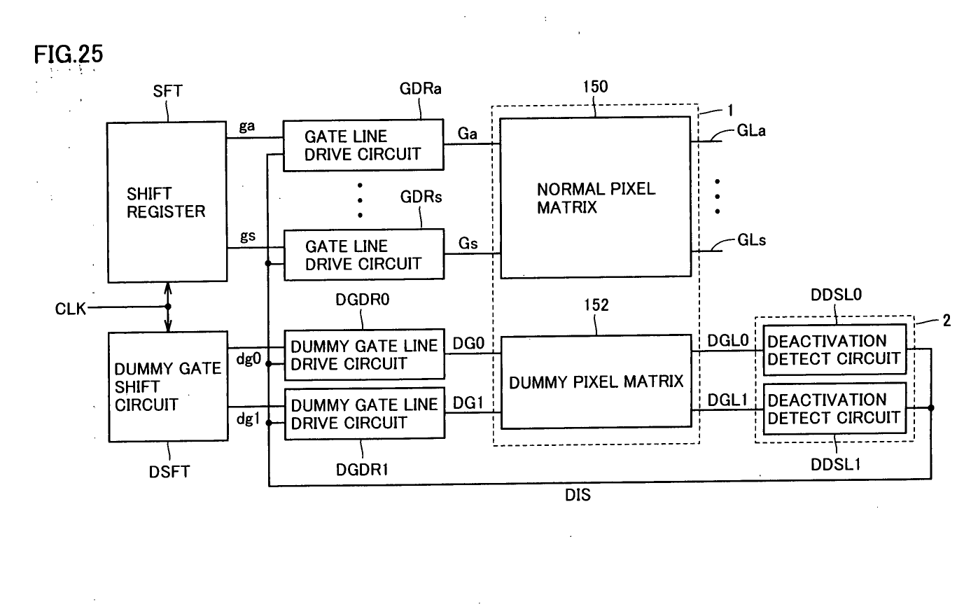

FIG. 25 schematically shows the configuration of a main portion of an image display device according to a fifth embodiment of the present invention. In FIG. 25, a display panel 1 includes a normal pixel matrix 150 in which normal pixels for displaying an image are arranged in rows and columns, and a dummy pixel matrix 152 in which dummy pixels having the same electric characteristics as the normal pixels are arranged in rows and columns. In normal pixel matrix 150, gate lines GLa-GLs are arranged, and gate line drive circuits GDRa-GDRs described in detail in the first embodiment are provided corresponding to gate lines GLa-GLs, respectively. These gate line drive circuits GDRa-GDRs are supplied with basic gate signals ga-gs from shift register SFT.

Dummy pixel matrix 152 may be provided on either side of the first gate line GL0 in the vertical scanning sequence or the last gate line GLn in the vertical scanning sequence of normal pixel matrix 150. In order to represent this flexibility in the arrangement position, in FIG. 25, gate lines GLa-GLs are shown instead of gate lines GL0-GLn. Specifically, gate line GLa may correspond to gate line GL0, or may correspond to gate line GLn.

In dummy pixel matrix 152, a plurality of (two in the present embodiment) dummy gate lines DGL0 and DGL1 are provided. To dummy gate lines DGL0 and DGL1 of the dummy pixel matrix, the activation detect circuits DDSL0 and DDSL1 described in detail in the first embodiment are provided, respectively, as deactivation transition detect circuit 2.

To dummy gate lines DGL0 and DGL1, dummy gate line drive circuits DG0 and DG1 having the same configuration as gate line drive circuits GDRa-GDRs are provided, respectively. Deactivation transition detect signal DIS from deactivation transition detect circuit 2 is applied in common to these gate line drive circuits GDRa-GDRs and dummy gate line drive circuits DGDR0 and DGDR1.

To dummy gate line drive circuits DGDR0 and DGDR1, a dummy shift circuit DSFT is provided. Dummy gate shift circuit DSFT generates basic dummy gate signals dg0 and dg1 to dummy gate line drive circuits DGDR0 and DGDR1. Basic dummy gate signals dg0 and dg1 are alternately activated in a cycle of clock signal CLK.

In this configuration shown in FIG. 25, dummy gate lines DGL0 and DGL1 having the same electric characteristics as gate lines GLa-GLs arranged in normal pixel matrix 150 are arranged in dummy pixel matrix 152. Therefore, the transition of dummy gate lines DGL0 and DGL1 from an active state to an inactive state occurs with the same characteristics as the transition of gate lines GLa-GLs arranged in normal pixel matrix 150 from an active state to an inactive state. Accordingly, by detecting the transition of dummy gate lines DGL0 and DGL1 from an active state to an inactive state with deactivation detect circuits DDLS0 and DDLS1, the transition of a selected gate line in normal pixel matrix 150 to an inactive state can reliably be detected.

Further, since deactivation detect circuits DDSL0 and DDSL1 are provided for dummy gate lines DGL0 and DGL1 and no deactivation detect circuits are provided for gate lines GLa-GLs, the circuit occupation area can be reduced.

Still further, in order to increase the drivability of output signal DIS of deactivation detect circuits DDSL0 and DDSL1, the sizes of transistors included in deactivation detect circuits DDSL0 and DDSL1 can be increased, to increase the drivability of deactivation transition detect signal DIS.

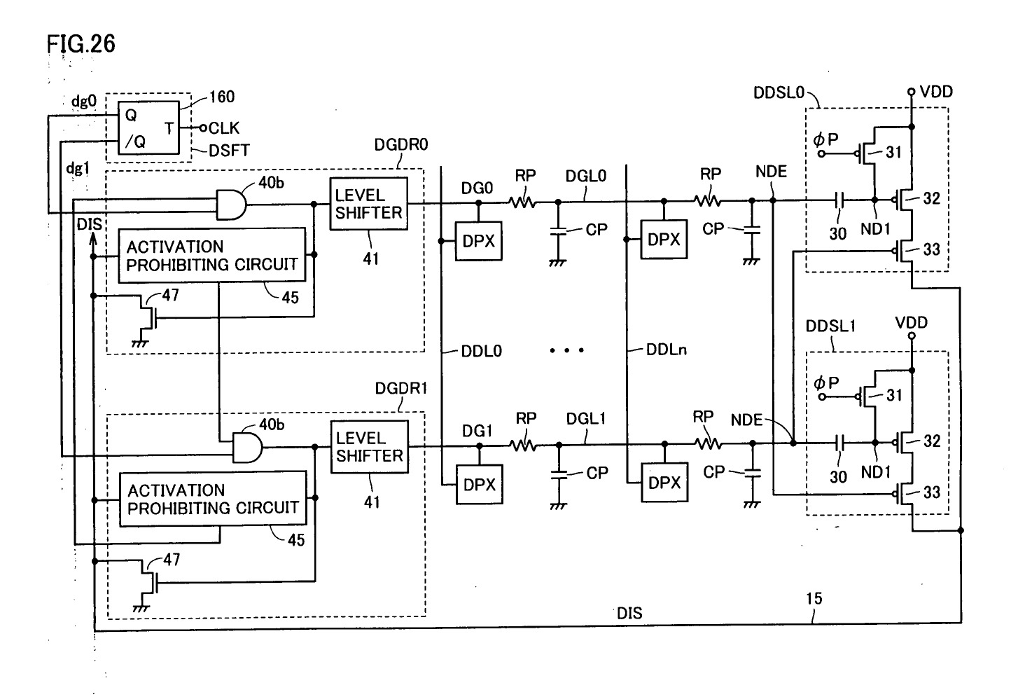

FIG. 26 shows the configuration of a portion related to dummy pixel matrix 152 shown in FIG. 25. In FIG. 26, dummy pixels DPX are coupled to each of dummy gate lines DGL0 and DGL1. Dummy pixel DPX has the same configuration and the same electric characteristics as pixel PX included in normal pixel matrix shown in FIG. 25.

Dummy data lines DDL0-DDLm are provided corresponding to the columns of dummy pixels DPX. These dummy data lines DDL0-DDLm may be continuously connected to data lines (DL0-DLm) included in normal pixel matrix 150 shown in FIG. 25, or these dummy data lines DDL0-DDLm may be coupled to a constant voltage source, to have their respective voltage levels fixed.

Dummy pixel DPX has the same electric characteristics as the pixel included in normal pixel matrix 150 shown in FIG. 25, and accordingly, dummy gate lines DGL0 and DGL1 have the same electric characteristics as gate lines GLa-GLs included in normal pixel matrix 150 (refer to FIG. 25), and similarly with gate lines GL0-GLn, have interconnection line (parasitic) resistance RP and parasitic capacitance CP every dummy pixel DPX.

Deactivation detect circuits DDSL0 and DDSL1 provided to the respective terminating end nodes NDE of dummy gate lines DGL0 and DGL1 have the same configuration as deactivation detect circuit DSLi shown in FIG. 5, and therefore, corresponding parts are denoted by the same reference numerals, and detailed description thereof is not repeated.

These dummy gate lines DGL0 and DGL1 are alternately driven to a selected state for each gate line activation cycle. Each of deactivation detect circuits DDSL0 and DDSL1 has the gate of MOS transistor 33 coupled to the terminating end node of the other dummy gate line. Specifically, the gate of MOS transistor 33 in deactivation detect circuit DDSL0 is coupled to dummy gate line DGL1, and, the gate of MOS transistor 33 in deactivation detect circuit DDSL1 is coupled to dummy gate line DGL0.

These deactivation detect circuits DDSL0 and DDSL1 are coupled to deactivation transition detect signal line 15 in common, to generate deactivation transition detect signal DIS.

Dummy gate line drive circuits DGDR0 and DGDR1, provided to the respective dummy gate lines DGL0 and DGL1, each have the same configuration as gate line drive circuit GDR1 shown in FIG. 6. Therefore, corresponding parts are denoted by the same reference numerals, and detailed description thereof is not repeated. An output signal of activation prohibiting circuit 45 of dummy gate line drive circuit DGDR0 is applied to a first input of AND gate 40b of dummy gate line drive circuit DGDR1, and an output signal of activation prohibit circuit 45 of dummy gate line drive circuit DGDR1 is applied to a first input of AND gate 40b of dummy gate line drive circuit DGDR0.

Dummy gate shift circuit DSFT includes T flip-flop (toggle flip-flop) 160 that changes its output state according to clock signal CLK. Basic dummy gate signals dg0 and dg1 are outputted from outputs Q and/Q of T flip-flop 160, respectively. These basic dummy gate signals dg0 and dg1 are applied to second inputs of AND gates 40b of dummy gate line drive circuits DGRD0 and DGRD1, respectively. By using T flip-flop 160, clock signal CLK can easily be frequency-divided, and dummy gate lines can alternately be driven to a selected state.

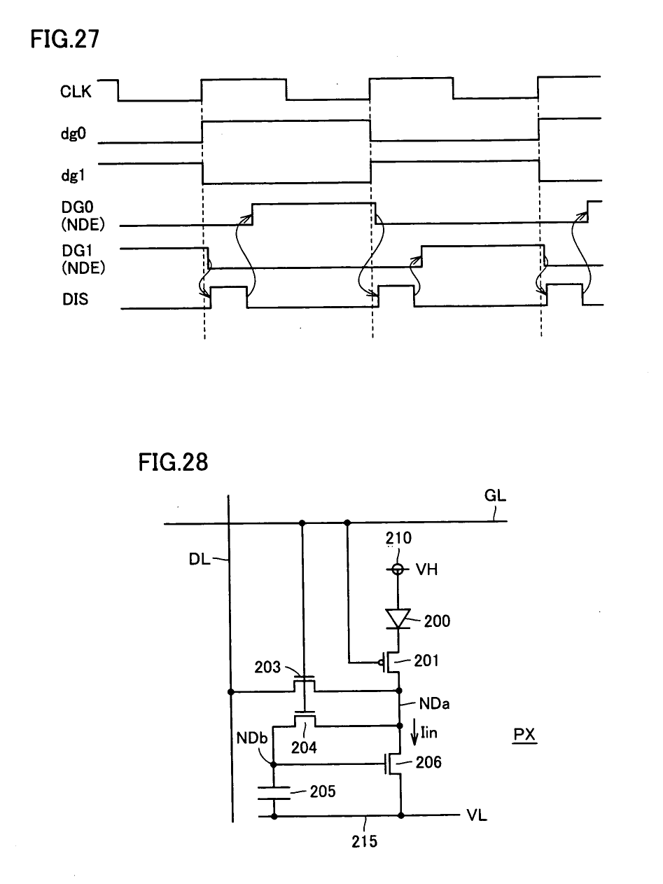

FIG. 27 is a timing diagram representing the operation of the circuit shown in FIG. 26. Now, referring to FIG. 27, the operation of the circuit shown in FIG. 26 is briefly described.

Dummy gate shift circuit DSFT changes its output state for each rising of clock signal CLK, and basic dummy signals dg0 and dg1 are alternately driven to an active state (H level) for each rising of clock signal CLK. When basic dummy gate signal dg1 is driven to a non-selected state and dummy gate signal DG1 at the terminating end node NDE in dummy gate line DGL1 falls to L level, the signal line 15 is driven by deactivation detect circuit DDSL1, and deactivation transition detect signal DIS attains H level. In response, activation prohibiting circuit 45 in dummy gate line drive circuit DGDR1 is set to the second state. In response, AND gate 40b in second gate line drive circuit DGDR0 raises its output signal to H level according to basic dummy gate signal dg0, and dummy gate signal DG0 is transmitted from level shifter 41 to dummy gate line DGL0. In response to the rising of the output signal of AND gate 40b, by MOS transistor 47 of dummy gate line drive circuit DGDR0, deactivation transition detect signal DIS falls to L level.

In the next cycle, the output state of toggle flip-flop 160 in dummy gate shift circuit DSFT changes in accordance with rising of clock signal CLK, basic dummy gate signal dg0 attains L level, while basic dummy gate signal dg1 attains H level. In response, dummy gate signal DG0 on dummy gate line DGL0 attains L level, and in response, deactivation transition detect signal DIS is driven to H level by deactivation transition detect circuit DDSL0. In response, activation prohibiting circuit 45 in dummy gate line drive circuit DGDR0 is set to the second state, the output signal of AND gate 40b of dummy gate line drive circuit DGDR1 attains H level, and dummy gate signal DG1 is transmitted to dummy gate line DGL1. Subsequently, this operation is repeatedly performed for each rising of clock signal CLK.

Each of dummy gate lines DGL0 and DGL1 has dummy pixel DPX arranged in alignment with the normal pixels in the normal pixel matrix, and is the same in electric characteristics as normal gate lines GLa-GLs. Therefore, by setting the timing for driving the dummy gate signals in accordance with deactivation transition detect signal DIS, in the normal pixel matrix also, the gate line of the next row can be driven to a selected state after a gate line in a selected state in gate lines GLa-GLs is transited to a non-selected state.

It should be noted that, in the configuration shown in FIG. 26, the output signal of AND gate 40b is applied to activation prohibiting circuit 45 in each of dummy gate line drive circuits DGDR0 and DGDR1. However, as in the second embodiment, the operation of activation prohibiting circuit 45 may be controlled using an output signal of level shifter 41. Additionally, this configuration using the dummy pixel matrix may be combined with the third or fourth embodiment.

As described above, according to the fifth embodiment of the present invention, a dummy gate line having the same electric characteristics as the gate line connecting to normal pixels is used, and has the voltage change thereon detected for setting the timing for driving the next gate line. Thus, the occupation area of the gate line deactivation transition detect circuitry can be reduced. Further, by increasing the transistor size in these deactivation transition circuits, the drivability for deactivation transition detect signal line can be increased, and the deactivation transition detecting timing can precisely be detected.

### Sixth Embodiment

FIG. 28 shows another configuration of a pixel of the image display device according to a sixth embodiment of the present invention. In FIG. 28, pixel PX includes an electro-luminescence element 200; a switching gate 201 configured of a P-channel MOS transistor rendered conductive when gate line GL is in a no-selected state, to couple a cathode of electro-luminescence element 200 to internal node NDa; a switching gate 203 configured of an N-channel MOS transistor rendered conductive when gate line GL is in a selected state, to couple internal node NDa to data line DL; a switching gate 204 configured of an N-channel MOS transistor rendered conductive when gate line GL is selected, to electrically couple internal node NDa to internal node NDb; a capacitive element 205 connected between internal node NDb and a low-side power supply line 215; and an N-channel MOS transistor 206 connected between internal node NDa and low-side power supply line 215 and having its gate connected to internal node NDb.

An anode of electro-luminescence element 200 is connected to a high-side power supply line 210. Voltages VH and VL are supplied to power supply lines 210 and 215, respectively.

Pixel PX shown in FIG. 28 is an electroluminescence element, and emits light corresponding to the driving current when a current flows in the element 200. Such pixels PX are arranged in rows and columns in a display panel.

In data writing (sampling period), write data (current) is supplied to data line DL. Gate line GL is driven to H level of a selected state, and switching gates 203 and 204 turn conductive, while switching gate 201 enters a non-conductive state. In this state, according to the current from data line DL, the current is supplied through switching gates 203, and capacitive element 205 is charged through switching gate 204. In this operation, MOS transistor 206 has its gate and drain interconnected through switching gate 204, and operates in a diode mode to pass current supplied from data line DL. Accordingly, charging voltage of capacitive element 205 (voltage at node NDb) will attain the voltage level corresponding to driving current Iin of MOS transistor 206.

When data write period (sampling period) completes, gate line GL attains L level of a non-selected state and switching gates 203 and 204 enter a non-conductive state, while switching gate 201 turns conductive. MOS transistor 206 has its gate voltage set by the charging voltage of capacitive element 205 and drives current Iin. In this state, since switching gate 201 is in a conductive state, the current driven by electro-luminescence element 200 attains the current level equal to driving current Iin of MOS transistor 206, and current Iin corresponding to the write data flows from high-side power supply line 210 to low-side power supply line 215, and electro-luminescence element 200 emits the light at the intensity corresponding to current Iin.

In the case where such pixel PX is configured of electro-luminescence element also, the charging voltage of capacitive element 205 will attain a voltage level different from that of write data if the multiple selection of gate lines GL occurs. Accordingly, with the configuration shown in any of the first to the fifth embodiments, after gate line GL is driven to a non-selected state, the gate line of the next row is driven to a selected state, or data writing is performed.

It is described in the above that a current is supplied from data line DL as write data to determine the driving current Iin of MOS transistor 206. However, a voltage (including a gradation voltage) may be supplied to data line DL. Capacitive element 205 is charged to a voltage level corresponding to the write data voltage supplied to data line DL. In this case, MOS transistor 206 drives a current corresponding to the voltage of node NDb, to determine the amount of driving current by electro-luminescence element 200.

Accordingly, even when the electro-luminescence elements as shown in FIG. 28 are arranged into the active matrix configuration, by using the configurations of the first to the fifth embodiments, data writing (sampling) can be performed precisely.

In the description above, a signal having a positive polarity that a selected state is H level is used as the gate line drive signal. However, by inverting the polarity of voltages and the conductivity type of transistors, the present invention is applicable to the case where the gate line drive signal of a negative polarity is used.

Additionally, an MOS transistor of constituent element is only needed to be a field effect transistor, and it may be an MOS transistor formed on a semiconductor substrate (applied to LCOS (Liquid Crystal On Silicon) devices), or a thin-film transistor (TFT) formed on an insulating substrate such as glass.

Still further, where a liquid crystal element is used as a display element, the present invention is applicable to both of transparency type and a reflection type.

As described above, according to the present invention, the transition of a gate line connecting to the pixels from a selected state to a non-selected state is detected to control an operation related to data writing of the next row. After the gate line in a selected state is transited into a non-selected state, the operation related to data writing in the next cycle is initiated automatically. Thus, designing of timings is facilitated, and a timing margin can be increased.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image display device, comprising:
a plurality of pixel elements arranged in rows and columns;
a plurality of gate lines, arranged corresponding to the rows of pixel elements and driven to a selected state in a prescribed sequence, each for transmitting, when selected, a select signal for driving pixel elements of a corresponding row to a selected state;
non-select transition detect circuitry arranged for said plurality of gate lines for detecting transition of a gate line in a selected state to a non-selected state; and
internal circuitry for performing an operation related to next image data writing in response to said non-select transition detect circuitry detecting the transition to the non-selected state.

2. The image display device according to claim 1, wherein
said internal circuitry includes a gate line select circuit for driving the select signal for a next gate line in said prescribed sequence to an active state in response to a signal indicating detection of the transition to the non-selected state from said non-select transition detect circuitry.

3. The image display device according to claim 1, wherein
said internal circuitry includes;
a shift circuit for generating a basic select signal driving said plurality of gate lines to a selected state in said prescribed sequence in synchronization with a clock signal,
a plurality of gate line activation prohibiting circuits, arranged corresponding to the respective gate lines, each being set to a first state in accordance with activation of a select signal for a corresponding gate line and set to a second state in accordance with activation of a non-selection transition detecting signal from said non-select transition detect circuitry, and
gate line drive circuits, arranged corresponding to the gate lines, for driving the select signal to a corresponding gate line in accordance with a corresponding basic select signal and the second state of the gate line activation prohibiting circuit of a preceding stage in said prescribed sequence.

4. The image display device according to claim 3, wherein
said internal circuitry further includes a plurality of initialization transistors, arranged corresponding to the respective gate lines, each for setting said non-selection transition detecting signal to an inactive state in response to a corresponding gate line being driven to the selected state.

5. The image display device according to claim 1, wherein
said non-select transition detect circuitry includes a plurality of deactivation detect circuits arranged corresponding to the respective gate lines,
the inactivation detect circuits each include;
a capacitive element having one electrode coupled to a corresponding gate line,
a precharge element for precharging other electrode of said capacitive element to a prescribed potential, and
a detection transistor for activating a non-select transition detecting signal indicating the transition in response to at least a potential of the other electrode of said capacitive element.

6. The image display device according to claim 5, wherein
the inactivation detect circuits each further includes a control transistor enabling activation of said non-select transition detect signal by said detect transistor in response to an inactive state of an adjacent gate line in said prescribed sequence.

7. The image display device according to claim 1, wherein
said plurality of pixel elements each include a display pixel element performing a displaying operation in accordance with an applied image signal.

8. The image display device according to claim 1, wherein
said plurality of pixel elements includes a plurality of normal display pixel elements displaying an image and a dummy pixel element arranged in alignment with the normal display pixel elements,
said plurality of gate lines include a normal gate line connecting to the normal display pixel elements, and a plurality of dummy gate lines connecting to the dummy pixel element, and
said non-select transition detect circuitry detects transition to the non-selected state according to a potential of the dummy gate lines to activate a non-select transition detect signal indicating the transition.

9. The image display device according to claim 8, wherein
said internal circuitry drives a designated normal gate line to the selected state in accordance with activation of said non-select transition detect signal.

10. The image display device according to claim 8, further comprising:
dummy select circuitry for generating a dummy basic gate signal sequentially selecting said plurality of dummy gate lines in accordance with a clock signal;
a plurality of activation prohibiting circuits, arranged corresponding to the respective dummy gate lines, each being set to a first state in accordance with activation of a select signal for a corresponding dummy gate line and set to a second state in accordance with activation of said non-select transition detect signal; and
a plurality of dummy gate drive circuits, arranged corresponding to the respective dummy gate lines, each for driving a corresponding dummy gate line to the selected state in accordance with the second state of an activation prohibiting circuit of a preceding stage in a dummy gate line selection sequence and a dummy basic select signal for a corresponding dummy gate line.

11. The image display device according to claim 1, wherein
said internal circuitry includes;
a latch circuit for latching and outputting digital pixel data for next image data in accordance with activation of a non-select transition detecting signal indicating the transition, and
a multiplexer for converting the data outputted from said latch circuit into an analog signal for outputting the converted analog signal.

12. The image display device according to claim 11, further comprising:
a plurality of data lines arranged corresponding to the respective columns of the pixel elements; and
data line drive circuitry driving the data lines in accordance with the signal received from said multiplexer.

13. The image display device according to claim 1, wherein
the pixel elements each include a display element having a counter electrode arranged opposing to a data storage node, and
said internal circuitry includes a voltage generate circuit for alternately selecting first and second voltages to be applied to said counter electrode in response to activation of said non-select transition detecting signal indicating the transition, a polarity of the voltage of said counter electrode changing for each activation of said non-select transition detect signal.
